(19) United States
(12) Patent Application Publication
(10) Pub. No.: US 2026/0121474 A1
(43) Pub. Date: Apr. 30, 2026

(54) COIL BODY, ARMATURE, AND ROTATING ELECTRIC MACHINE

(71) Applicant: DENSO CORPORATION, Kariya-city (JP)

(72) Inventors: Yusuke TATEISHI, Kariya-city (JP); Shinji MAKITA, Kariya-city (JP); Keisuke KOIDE, Kariya-city (JP); Yuji HAYASHI, Kariya-city (JP)

(73) Assignee: DENSO CORPORATION, Kariya-city (JP)

(21) Appl. No.: 19/431,149

(22) Filed: Dec. 23, 2025

Related U.S. Application Data
(63) Continuation of application No. PCT/JP2024/019417, filed on May 27, 2024.

(30) Foreign Application Priority Data
Jun. 23, 2023 (JP) 2023-103767

(51) Int. Cl. H02K 3/28; H02K 1/06

(52) U.S. Cl. CPC H02K 3/28; H02K 1/06

(57) ABSTRACT

A coil body, an armature, and rotating electric machine are provided. The coil body includes a base member, a magnetic field generation portion, and a reinforcing portion. The base member is formed into a shape extending in a radial direction using an insulating material and stacked in an axial direction. The magnetic field generation portion is formed in the base member using a conductive material and generates a rotating magnetic field by being energized. The reinforcing portion is formed in a region differing from a region in which the magnetic field generation portion is formed on a surface of the base material facing the axial direction. The armature includes the coil body. The rotating electric machine includes a stator and a rotor, in which either thereof is configured to include the armature, and the other thereof has a magnet disposed opposing the coil body in an axial direction.

### CROSS-REFERENCE TO RELATED APPLICATION

The present application is a continuation application of International Application No. PCT/JP2024/019417, filed on May 27, 2024, which claims priority to Japanese Patent Application No. 2023-103767, filed on Jun. 23, 2023. The contents of these applications are incorporated herein by reference in their entirety.

### BACKGROUND

The present disclosure relates to a coil body, an armature, and a rotating electric machine.

A coil for a rotating electric machine such as a motor is known. The coil includes a coil plate that is configured by a plurality of coil plate elements and has a predetermined coil winding pattern.

### SUMMARY

One aspect of the present disclosure provides a coil body that includes a base member, a magnetic field generation portion, and reinforcing portion. The base member is formed into a shape extending in a radial direction using an insulating material and stacked in an axial direction. The magnetic field generation portion is formed in the base member using a conductive material and generates a rotating magnetic field by being energized. The reinforcing portion is formed in a region differing from a region in which the magnetic field generation portion is formed on a surface of the base material facing the axial direction.

### BRIEF DESCRIPTION OF THE DRAWINGS

In the accompanying drawings:

FIG. 1 is a perspective view of a motor showing a portion of the motor in a cut-away state;

FIG. 2 is an exploded perspective view in which the motor is deconstructed, showing a portion of components in a cut-away state;

FIG. 3 is an exploded perspective view of a coil body, showing a portion of the coil body in a cut-away state;

FIG. 4 is a plan view schematically showing the coil body;

FIG. 5 is a diagram for explaining a star connection;

FIG. 6 is a plan view schematically showing a single substrate, and a coil portion and the like formed on the single substrate;

FIG. 7 is a cross-sectional view showing a cross section of a portion of a substrate of a specific layer and the coil portion formed on the substrate, in the coil portion of the motor;

FIG. 8 is a cross-sectional view showing a cross section of a portion of substrates of a plurality of layers and the coil portions respectively formed on the substrates of the plurality of layers, in the coil portion of the motor;

FIG. 9 is a plan view showing a single substrate configuring a portion of a coil body of a motor according to a first embodiment, and a plurality of coil portions and the like formed on the substrate;

FIG. 10 is a cross-sectional view schematically showing a cross section of the substrate and the like taken along line A-A shown in FIG. 9;

FIG. 11 is a plan view schematically showing a single substrate configuring a portion of a coil body of a motor according to a second embodiment, and a magnetic field generation portion and the like formed on the substrate;

FIG. 12 is a cross-sectional view schematically showing a cross section of the substrate and the like taken along line A-A shown in FIG. 11;

FIG. 13 is a plan view schematically showing a single substrate configuring a portion of a coil body of a motor according to a third embodiment, and a magnetic field generation portion and the like formed on the substrate;

FIG. 14 is a cross-sectional view schematically showing a cross section of the substrate and the like taken along line A-A shown in FIG. 13;

FIG. 15 is a cross-sectional side view schematically showing a motor according to a fourth embodiment;

FIG. 16 is a cross-sectional side view schematically showing a motor according to a fifth embodiment;

FIG. 17 is a plan view schematically showing a single substrate configuring a portion of a coil body of a motor according to a sixth embodiment, and a magnetic field generation portion and the like formed on the substrate;

FIG. 18 is a cross-sectional view schematically showing a cross section of the substrate and the like taken along line A-A shown in FIG. 17;

FIG. 19 is a plan view schematically showing a single substrate configuring a portion of a coil body of a motor according to a seventh embodiment, and a magnetic field generation portion and the like formed on the substrate;

FIG. 20 is a plan view schematically showing a single substrate configuring a portion of a coil body of a motor according to an eighth embodiment, and a magnetic field generation portion and the like formed on the substrate;

FIG. 21 is a plan view schematically showing a single substrate configuring a portion of a coil body of a motor according to a ninth embodiment, and a magnetic field generation portion and the like formed on the substrate;

FIG. 22 is a plan view schematically showing a single substrate configuring a portion of a coil body of a motor according to a tenth embodiment, and a magnetic field generation portion and the like formed on the substrate;

FIG. 23 is a plan view schematically showing a single substrate configuring a portion of a coil body of a motor according to an eleventh embodiment, and a magnetic field generation portion and the like formed on the substrate;

FIG. 24 is a plan view schematically showing a single substrate configuring a portion of a coil body of a motor according to a twelfth embodiment, and a magnetic field generation portion and the like formed on the substrate;

FIG. 25 is a plan view schematically showing a single substrate configuring a portion of a coil body of a motor according to a thirteenth embodiment, and a magnetic field generation portion and the like formed on the substrate;

FIG. 26 is a plan view schematically showing a part of a single substrate configuring a portion of a coil body of a motor according to a fourteenth embodiment, and a magnetic field generation portion and the like formed on the substrate;

FIG. 27 is a perspective view schematically showing a process for stacking substrates;

FIG. 28 is a plan view corresponding to FIG. 26 showing an engaging portion of another example;

FIG. 29 is a plan view corresponding to FIG. 26 showing an engaging portion of another example;

FIG. 30 is a plan view corresponding to FIG. 26 showing an engaging portion of another example;

FIG. 31 is a plan view schematically showing a coil body of a motor according to a fifteenth embodiment;

FIG. 32 is a cross-sectional view schematically showing a cross section of the substrate and the like taken along line A-A shown in FIG. 31;

FIG. 33 is a cross-sectional side view schematically showing a single substrate configuring a portion of a coil body of a motor according to a sixteenth embodiment, and a magnetic field generation portion and the like formed on the substrate;

FIG. 34 is a cross-sectional side view schematically showing a single substrate configuring a portion of a coil body of a motor according to a seventeenth embodiment, and a magnetic field generation portion and the like formed on the substrate;

FIG. 35 is a diagram schematically showing a process for cutting a substrate and the like with a punch, showing a state before cutting;

FIG. 36 is a diagram schematically showing the process for cutting a substrate and the like with a punch, showing a state after completion of cutting;

FIG. 37 is a plan view showing an example in which a shape of an outer edge of the substrate is rectangular;

FIG. 38 is a plan view showing an example in which the shape of the outer edge of the substrate is hexagonal;

FIG. 39 is a plan view showing an example in which the shape of the outer edge of the substrate is dodecagonal;

FIG. 40 is a plan view schematically showing a single substrate configuring a portion of a coil body of a motor according to an eighteenth embodiment, and a magnetic field generation portion and the like formed on the substrate; and

FIG. 41 is a cross-sectional side view schematically showing a single substrate configuring a portion of a coil body of a motor according to a nineteenth embodiment, and a magnetic field generation portion and the like formed on the substrate.

### DESCRIPTION OF THE EMBODIMENTS

JP 2008-061357 A discloses a coil for a rotating electric machine that is used in a rotating electric machine such as a motor. The coil for a rotating electric machine described in the literature includes a plurality of coil plate elements formed in a disk shape, and a predetermined wiring pattern is formed on these coil plate elements. In addition, the coil plate elements are joined to one another at inner peripheral portions and outer peripheral portions while being separated at intermediate portions, thereby configuring a coil plate that has a predetermined coil winding pattern.

In a coil body (the coil for a rotating electric machine) having the configuration described in JP 2008-061357 A, above, it is thought that ensuring strength of the coil body becomes difficult if the coil plate elements become thinner.

It is thus desired to provide a coil body of which strength can be ensured in a configuration in which base members are stacked in an axial direction, an armature, and a rotating electric machine.

A first exemplary embodiment of the present disclosure provides a coil body that includes: a base member formed into a shape extending in a radial direction using an insulating material and stacked in an axial direction; a magnetic field generation portion formed in the base member using a conductive material and generating a rotating magnetic field by being energized; and a reinforcing portion formed in a region differing from a region in which the magnetic field generation portion is formed on a surface of the base material facing the axial direction.

A second exemplary embodiment of the present disclosure provides an armature includes the coil body described above.

A third exemplary embodiment of the present disclosure provides a rotating electric machine includes a stator and a rotor, in which either of the stator and the rotor is configured to include the armature described above, and the other of the stator and the rotor includes a magnet disposed opposing the coil body in the axial direction.

According to the above-described exemplary embodiments, in a configuration in which the base material is stacked in the axial direction, strength of the coil body can be ensured.

The above-described exemplary embodiments of the present disclosure will be further clarified through the detailed description herebelow, with reference to the accompanying drawings.

### Basic Configuration of a Motor

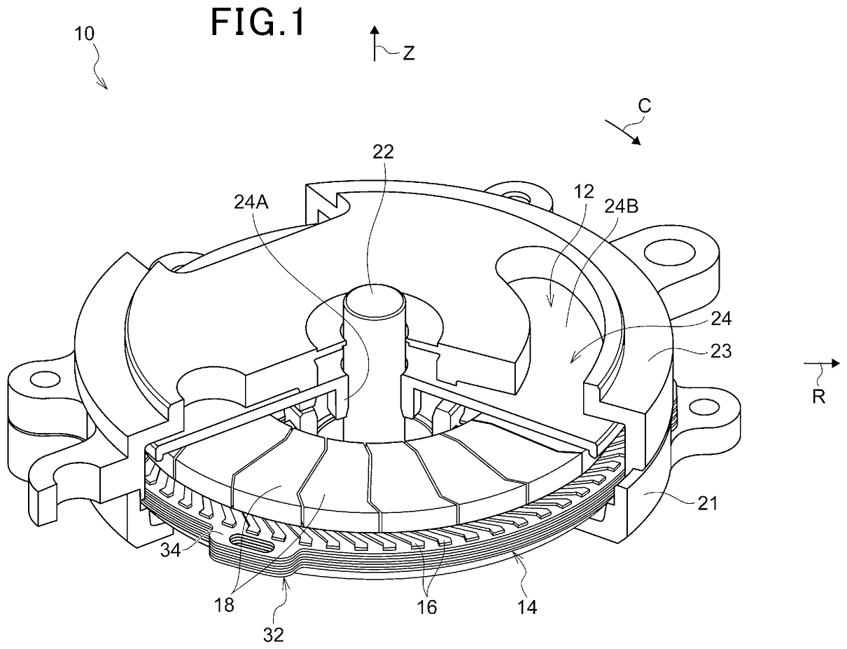

A basic configuration of a motor 10 according to an embodiment of the present disclosure will be described with reference to FIG. 1 to FIG. 8. Here, an arrow Z direction, an arrow R direction, and an arrow C direction shown in the drawings as appropriate respectively indicate one side in a rotational axial direction, an outer side in a rotational radial direction, and one side in a rotational circumferential direction of a rotor 12, described hereafter. In addition, when merely an axial direction, a radial direction, or a circumferential direction is given hereafter, the rotational axial direction, the rotational radial direction, or the rotational circumferential direction of the rotor 12 is indicated unless stated otherwise. Furthermore, the motor 10 and motors according to embodiments described hereafter are examples of a rotating electric machine.

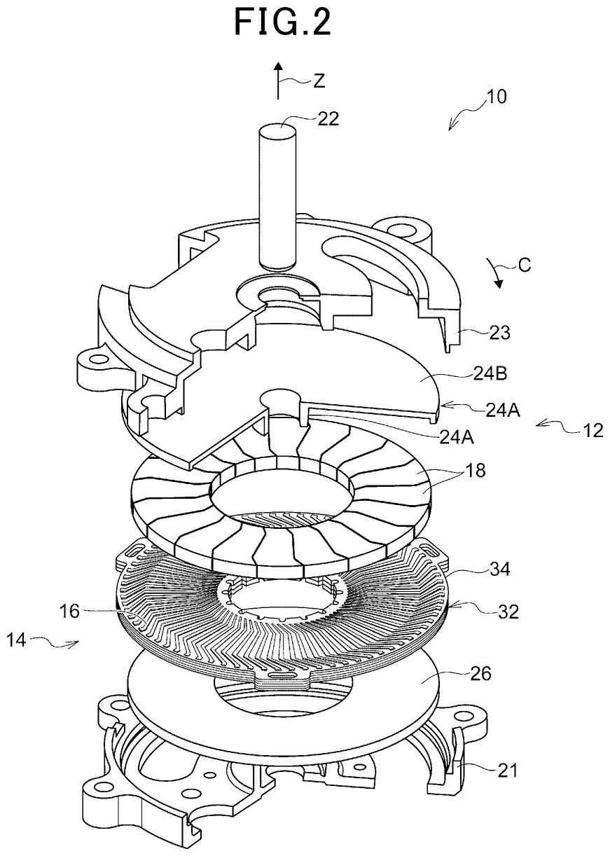

As shown in FIG. 1 and FIG. 2, the motor 10 is an axial-gap-type brushless motor in which the rotor 12 serving as a rotor, and a stator 14 serving as an armature and a stator are disposed opposing each other in the axial direction. Here, the drawings in FIG. 1 and FIG. 2 are drawings of the motor 10 and the like given as an example. Numbers of coil portions 16, numbers of magnets 18, and detailed shapes do not coincide with descriptions given hereafter in some sections.

The rotor 12 is configured to include a rotating shaft 22 rotatably supported by a pair of bearings (not shown), a rotor core 24 fixed to the rotating shaft 22, and a plurality of magnets 18 fixed to a surface of the rotor core 24 on another side in the axial direction. Here, the pair of bearings are respectively supported by a frame 21 and a frame end 23. The stator 14 and the like are housed between the frame 21 and the frame end 23.

The rotor core 24 includes a first cylindrical portion 24A formed into a cylindrical shape and to which the rotating shaft 22 is fixed by press-fitting or the like, and a disk portion 24B extending outward in the radial direction from an end portion of the first cylindrical portion 24A on one side in the axial direction. The disk portion 24B is formed into a disk shape of which a thickness direction is in the axial direction. The magnet 18, described hereafter, is fixed to the surface of the disk portion 24B on the other side in the axial direction.

The plurality of magnets 18 are formed using a magnetic compound having an intrinsic coercive force Hc of 400 [kA/m] or greater and a residual magnetic flux density Br of 1.0 [T] or greater. As an example, the magnet 18 is formed using a magnetic compound such as NdFe11TiN, Nd2Fe14B, Sm2Fe17N3, or FeNi. In addition, the plurality of magnets 18 are fixed to the surface of the disk portion 24B of the rotor core 24 on the other side in the axial direction. Furthermore, the magnet 18 of which a surface on the other side in the axial direction is an N pole and the magnet 18 of which a surface on the other side in the axial direction is an S pole are arranged in an alternating manner in the circumferential direction. The number of magnets 18 may be set as appropriate, taking into consideration output required of the motor 10 and the like.

The stator 14 includes a stator core 26 formed into an annular shape and serving as an armature core, and a coil body 32 disposed along a surface of the stator core 26 on one side in the axial direction. The stator 14 according to the present embodiment has a toothless structure in which a portion of the stator core 26 is not disposed between coil portions 16 configuring a portion of the coil body 32.

The stator core 26 is formed using a soft magnetic material such as a steel material. The stator core 26 is formed into a plate shape of which a thickness direction is in the axial direction and is formed having an annular shape when viewed from the axial direction. The stator core 26 is disposed coaxially with the rotor 12. A center position in the radial direction of the stator core 26 and a center position in the radial direction of the plurality of magnets 18 fixed to the rotor core 24 coincide in the radial direction.

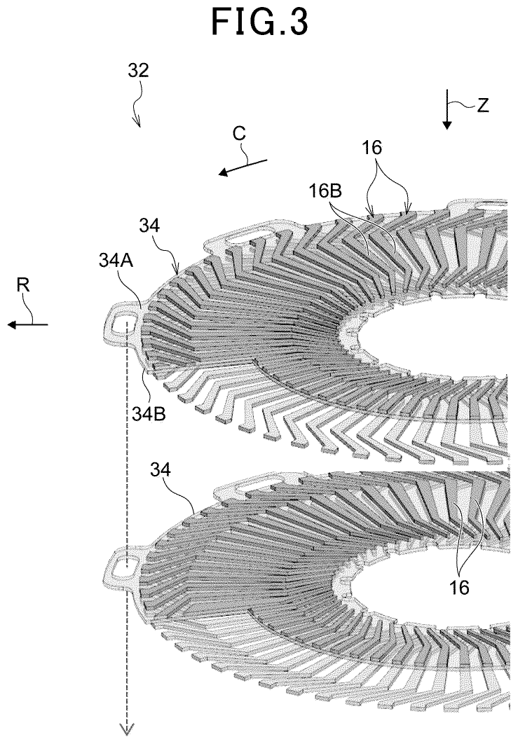

As shown in FIG. 3, the coil body 32 is configured to include a plurality of substrates 34 serving as a base member formed into a sheet shape using an insulating material, and a plurality of coil portions 16 respectively formed on the plurality of substrates 34.

The substrate 34 is formed into a plate shape of which a thickness direction is in the axial direction and is formed having an annular shape when viewed from the axial direction. Here, the substrate 34 may be a flexible substrate that can be bent in the thickness direction thereof, or may be a substrate that cannot be bent in the thickness direction thereof. In addition, the coil body 32 according to the present embodiment has a configuration in which the plurality of substrates 34 are stacked in the axial direction.

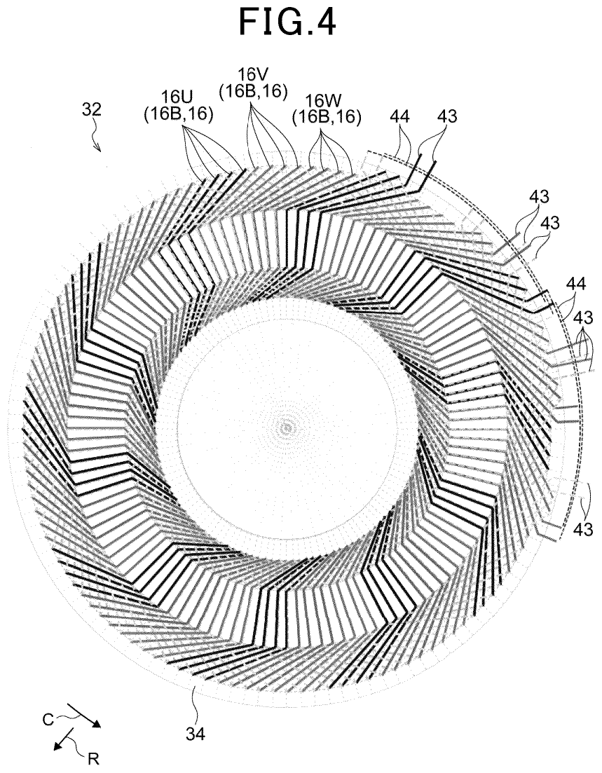

As shown in FIG. 3 and FIG. 4, the plurality of coil portions 16 configure a magnetic field generation portion 80 that generates a rotating magnetic field. The plurality of coil portions 16 are respectively formed on the plurality of substrates 34. In addition, as a result of the plurality of substrates 34 being stacked in the axial direction, the plurality of coil portions 16 are disposed at predetermined positions in the circumferential direction and the axial direction.

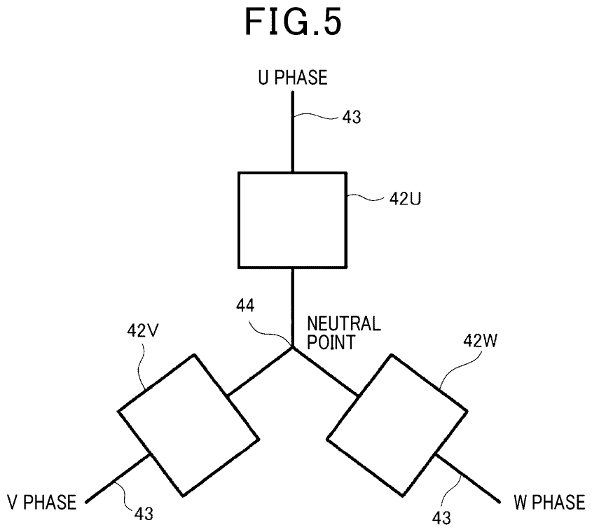

Here, as shown in FIG. 5, the plurality of coil portions 16 configuring a U phase (U-phase coil group 42U), the plurality of coil portions 16 configuring a V phase (V-phase coil group 42V), and a plurality of coil portions 16 configuring a W phase (W-phase coil group 42W) are connected in a star connection. That is, an end portion on a side opposite an input/output portion 43 serving as an input/output path for currents in the U-phase coil group 42U, an end portion on a side opposite an input/output portion 43 serving as an input/output path for currents in the V-phase coil group 42V, and an end portion on a side opposite an input/output portion 43 serving as an input/output path for currents in the W-phase coil group 42W are connected at a neutral point 44.

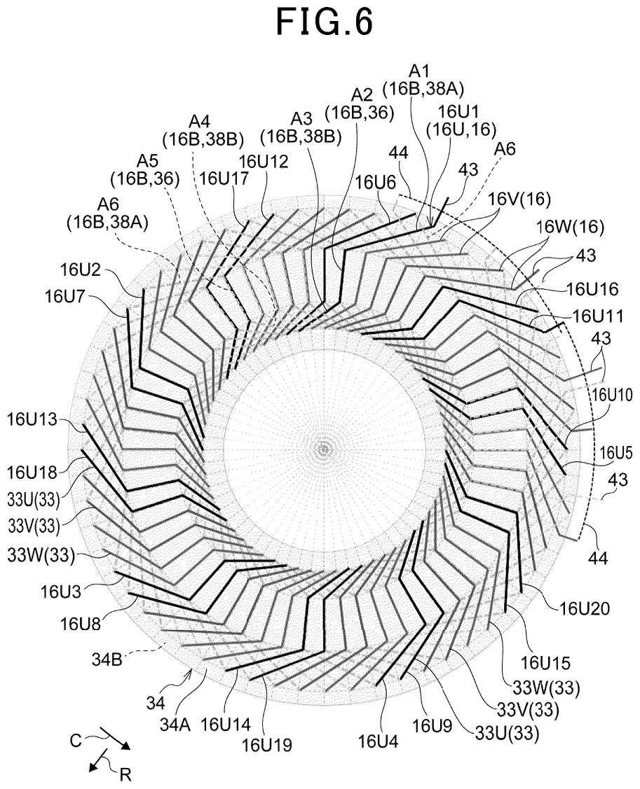

FIG. 6 shows the substrate 34 of a first layer and a plurality of coil portions 16 formed on the substrate 34. Here, twenty coil portions 16 configuring the U phase, twenty coil portions 16 configuring the V phase, and twenty coil portions 16 configuring the W phase are formed on the substrate 34 of the first layer. Here, in the descriptions hereafter, the coil portion 16 configuring the U phase may be referred to as a coil portion 16U. Also, the coil portion 16 configuring the V phase may be referred to as a coil portion 16V. Also, the coil portion 16 configuring the W phase may be referred to as a coil portion 16W. In addition, in the descriptions hereafter, the twenty coil portions 16 configuring the U phase may be referred to as a coil portion 16U1 to coil portion 16U20. Also, the twenty coil portions 16 configuring the V phase may be referred to as a coil portion 16V1 to coil portion 16V20. Also, the twenty coil portions 16 configuring the W phase may be referred to as a coil portion 16W1 to coil portion 16W20.

Specifically, the coil portion 16U1 includes a first extending portion A1 that slopes further inward in the radial direction toward the one side in the circumferential direction and a second extending portion A2 that extends inward in the radial direction from an end of the first extending portion A1 on one side in the circumferential direction. In addition, the coil portion 16U1 includes a third extending portion A3 that slopes further inward in the radial direction toward the one side in the circumferential direction from an end of the second extending portion A2 on a side opposite the first extending portion A1, and a fourth extending portion A4 that slopes further outward in the radial direction toward one side in the circumferential direction from an end of the third extending portion A3 on a side opposite the second extending portion A2. Furthermore, the coil portion 16U1 has a fifth extending portion A5 that extends outward in the radial direction from an end of the fourth extending portion A4 on a side opposite the third extending portion A3, and a sixth extending portion A6 that slopes further outward in the radial direction toward one side in the circumferential direction from an end of the fifth extending portion A5 on a side opposite the fourth extending portion A4. Here, in the descriptions hereafter, the first extending portion A1 to the sixth extending portion A6 may be referred to as conductor portions 16B. In the coil body 32 of the present configuration, the configuration is such that the conductor portions 16B are regularly arrayed in the circumferential direction.

Here, the first extending portion A1, the second extending portion A2, and the third extending portion A3 are formed on a surface 34A side on one side of the substrate 34 (a surface on the stator core 26 side and facing the other side in the axial direction). In addition, the fourth extending portion A4, the fifth extending portion A5, and the sixth extending portion A6 are formed on a surface 34B side on an other side of the substrate 34 (a surface on a side opposite the stator core 26 and facing one side in the axial direction). The third extending portion A3 and the fourth extending portion A4 may be electrically connected by a via hole or a through hole (not shown), for example. Here, in FIG. 6, a portion of the coil portion 16U1 formed on the surface 34A on one side of the substrate 34 is indicated by a solid line. In addition, a portion of the coil portion 16U1 formed on the surface 34B on the other side of the substrate 34 is indicated by a broken line.

Moreover, the second extending portion A2 and the fifth extending portion A5 described above may be referred to as vertical portions 36. Also, the first extending portion A1 and the sixth extending portion A6 may be referred to as outer coil end portions 38A serving as one coil end portions, and the third extending portion A3 and the fourth extending portion A4 may be referred to as inner coil end portions 38B serving as other coil end portions. Furthermore, as a result of a single coil portion 16 having the first extending portion A1 to the sixth extending portion A6, a shape of the single coil portion 16U1 viewed from the thickness direction of the substrate 34 has a substantially V-like shape that is open on the outer side in the radial direction of the substrate 34 and closed on the inner side in the radial direction.

The other coil portion 16U2 to coil portion 16U20 configuring the U phase are also configured in a manner similar to the coil portion 16U1. That is, all of the coil portions 16 configuring the U phase have substantially identical configurations.

The coil portion 16U2 connected to the coil portion 16U1 is disposed on one side in the circumferential direction relative to the coil portion 16U1 . Also, the coil portion 16U3 connected to the coil portion 16U2 is disposed on one side in the circumferential direction relative to the coil portion 16U2 . Also, the coil portion 16U4 connected to the coil portion 16U3 is disposed on one side in the circumferential direction relative to the coil portion 16U3. Also, the coil portion 16U5 connected to the coil portion 16U4 is disposed on the one side in the circumferential direction relative to the coil portion 16U4. Here, the sixth extending portion A6 of the coil portion 16U5 and the first extending portion U1 of the coil portion 16U1 intersect when viewed from the axial direction. As a result, the end of the coil portion 16U5 on the side connected to the coil portion U6 is positioned on one side in the circumferential direction relative to the end portion of the coil portion 16U1 on the input/output portion 43 side.

In addition, the coil portion U6 connected to the coil portion 16U5 is disposed on one side in the circumferential direction relative to the coil portion 16U5 and is disposed adjacent to the coil portion 16U1 in the circumferential direction. Also, the coil portion 16U7 connected to the coil portion U6 is disposed on one side in the circumferential direction relative to the coil portion U6 and is disposed adjacent to the coil portion 16U2 in the circumferential direction. Also, the coil portion 16U8 connected to the coil portion 16U7 is disposed on one side in the circumferential direction relative to the coil portion 16U7 and is disposed adjacent to the coil portion 16U3 in the circumferential direction. Also, the coil portion 16U9 connected to the coil portion 16U8 is disposed on one side in the circumferential direction relative to the coil portion 16U8 and is disposed adjacent to the coil portion 16U4 in the circumferential direction. Also, the coil portion 16U10 connected to the coil portion 16U9 is disposed on one side in the circumferential direction relative to the coil portion 16U9 and is disposed adjacent to the coil portion 16U5 in the circumferential direction. The end portion of the coil portion 16U10 on a side opposite the coil portion 16U9 is the neutral point 44.

The coil portions 16U11 to 16U20 connected in parallel to the coil portions 16U1 to 16U10 are configured in a manner similar to the coil portions 16U1 to 16U10 . The coil portions 16U11 to 16U20 are disposed such as to be offset by 36° to the other side in the circumferential direction relative to the coil portions 16U1 to 16U10 , respectively. As a result, the vertical portions 36 of the coil portions 16U11 to 16U20 and the vertical portions 36 of the coil portions 16U1 to 16U10 are disposed in same positions in the circumferential direction. Here, the coil portions 16U1 to 16U10 that are connected in series are referred to as a conductor layer 33, and the coil portions 16U11 to 16U20 that are connected in series are referred to as a conductor layer 33. According to the present embodiment, two conductor layers 33U of the U phase are provided on a single substrate 34.

Here, although detailed descriptions with reference numbers in the drawings are omitted, the coil portions 16V1 to 16V20 configuring the V phase have a configuration similar to that of the coil portions 16U1 to 16U20 configuring the U phase. The coil portions 16V1 to 16V20 configuring the V phase are disposed such as to be offset by 12° to the other side in the circumferential direction relative to the coil portions 16U1 to 16U20 configuring the U phase. Here, the coil portions 16V1 to 16V10 that are connected in series are referred to as the conductor layer 33, and the coil portions 16V11 to 16V20 that are connected in series are referred to as the conductor layer 33. According to the present embodiment, two conductor layers 33V of the V phase are provided on a single substrate 34. In addition, the coil portions 16W1 to 16W20 configuring the W phase have a configuration similar to that of the coil portions 16U1 to 16U20 configuring the U phase. The coil portions 16W1 to 16W0 configuring the W phase are disposed such as to be offset by 12° to the other side in the circumferential direction relative to the coil portions 16V1 to 16V20 configuring the V phase. Here, the coil portions 16W1 to 16W10 that are connected in series are referred to as the conductor layer 33, and the coil portions 16W11 to 16W20 that are connected in series are referred to as the conductor layer 33. According to the present embodiment, two conductor layers 33W of the W phase are provided on a single substrate 34.

The substrate 34 of a second layer stacked on the substrate 34 of the first layer and the plurality of coil portions 16 formed on the substrate 34 of the second layer have configurations similar to those of the substrate 34 of the first layer and the plurality of coil portions 16 formed on the substrate 34 of the first layer. According to the present embodiment, a pattern of the plurality of coil portions 16 formed on the substrate 34 of the first layer and a pattern of the plurality of coil portions 16 formed on the substrate 34 of the second layer coincide. The plurality of coil portions 16 formed on the substrate 34 of the second layer are disposed such as to be offset by 6° to the other side in the circumferential direction relative to the plurality of coil portions 16 formed on the substrate 34 of the first layer. Then, as a result of the substrate 34 of the first layer and the substrate 34 of the second layer being stacked in the axial direction, the plurality of coil portions 16 formed on the substrate 34 of the first layer and the plurality of coil portions 16 formed on the substrate 34 of the second layer are disposed at predetermined positions in the circumferential direction and the axial direction.

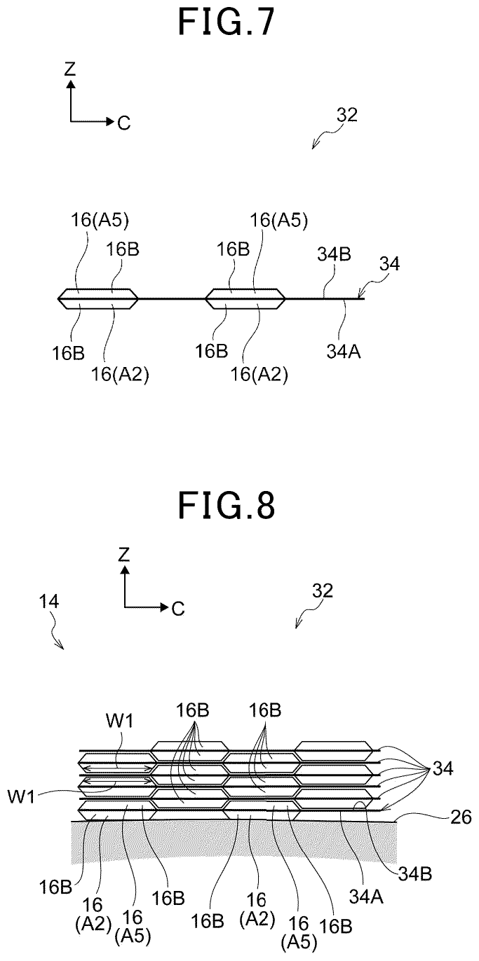

Here, FIG. 4 is a diagram schematically showing a state in which the substrate 34 of the first layer and the substrate 34 of the second layer are stacked. In the drawing, each section of the coil portions 16 disposed between the substrate 34 of the first layer and the substrate 34 of the second layer are shown by solid lines, and other sections of the coil portions 16 are shown by broken lines. As shown in the drawing, sections of the coil portions 16 formed on the substrate 34 in the first layer and sections of the coil portions 16 formed on the substrate 34 in the second layer are disposed in an alternating manner along the circumferential direction and overlap each other in the circumferential direction. Here, this point will be described in detail hereafter with reference to further simplified FIG. 7 and FIG. 8.

Here, the substrate 34 of a third layer and the substrate 34 of a fourth layer are also stacked having a relationship similar to the relationship between the substrate 34 of the first layer and the substrate 34 of the second layer. In addition, in a configuration having five (three layers) or more of the substrates 34, the substrates 34 are stacked having a relationship similar to the relationship between the substrate 34 of the first layer and the substrate 34 of the second layer. A number of coil bodies 32 that are stacked (a number of substrates 34 that are stacked) may be set as appropriate, taking into consideration the output required of the motor 10 and the like.

FIG. 7 and FIG. 8 show cross sections in which a portion of the coil body 32 is cut away along the axial direction and the circumferential direction. Specifically, FIG. 7 shows a cross section of a portion of the substrate 34 of a particular layer and the coil portion 16 (conductor portion 16B) formed on the substrate 34. FIG. 8 also shows a cross section of a portion of the substrates 34 of a plurality of layers and the coil portions 16 (conductor portions 16B) respectively formed on the substrates 34 of the plurality of layers. Here, in FIG. 7 and FIG. 8, shading of cross sections is omitted. As shown in FIG. 7 and FIG. 8, according to the present embodiment, in the state in which the substrate 34 of one layer and the substrate 34 of another layer are stacked in the axial direction, the conductor portion 16B formed on the substrate 34 of one layer and the conductor portion 16B formed on the substrate 34 of the other layer are disposed such as to alternate along the circumferential direction. In addition, in the state in which the substrate 34 of one layer and the substrate 34 of another layer are stacked in the axial direction, the plurality of conductor portions 16B formed on the substrate 34 of one layer and the plurality of conductor portions 16B formed on the substrate 34 of the other layer overlap in the circumferential direction. Furthermore, as shown in FIG. 4 , FIG. 6, FIG. 7, and FIG. 8, in the state in which the substrate 34 of one layer and the substrate 34 of another layer are stacked in the axial direction, the conductor portions 16B (vertical portions 36) of the coil portions 16 of the same phase are arrayed in the axial direction.

In addition, according to the present embodiment, a width dimension W1 in the circumferential direction of the conductor portion 16B formed on the substrate 34 of one layer gradually decreases toward the substrate 34 of the other layer. Furthermore, the width dimension W1 in the circumferential direction of the conductor portion 16B formed on the substrate 34 of the other layer gradually decreases toward the substrate 34 of the one layer.

### Workings and Effects

Next, workings and effects of the motor 10 according to the present embodiment will be described.

As shown in FIG. 1, FIG. 2, FIG. 4, and FIG. 5, in the motor 10 according to the present embodiment, a rotating magnetic field is generated in the stator 14 by energization of the U-phase coil group 42U, the V-phase coil group 42V, and the W-phase coil group 42W configuring a portion of the stator 14 being switched. As a result, the rotor 12 rotates.

Here, the coil body 32 is configured to include the plurality of substrates 34 and the plurality of coil portions 16 respectively formed on the plurality of substrates 34. Then, as a result of the plurality of substrates 34 being stacked in the axial direction, the plurality of coil portions 16 are disposed at predetermined positions in the circumferential direction and the axial direction. In this configuration, increase in physical size of the coil body 32 in the axial direction can be suppressed, compared to a configuration having a coil configured such that a winding is wound around teeth. Consequently, increase in the physical size of the motor 10 can be suppressed.

### Configurations for Ensuring Strength of the Coil Body 32

Next, configurations according to embodiments for ensuring strength of the coil body 32 will be described.

### First Embodiment

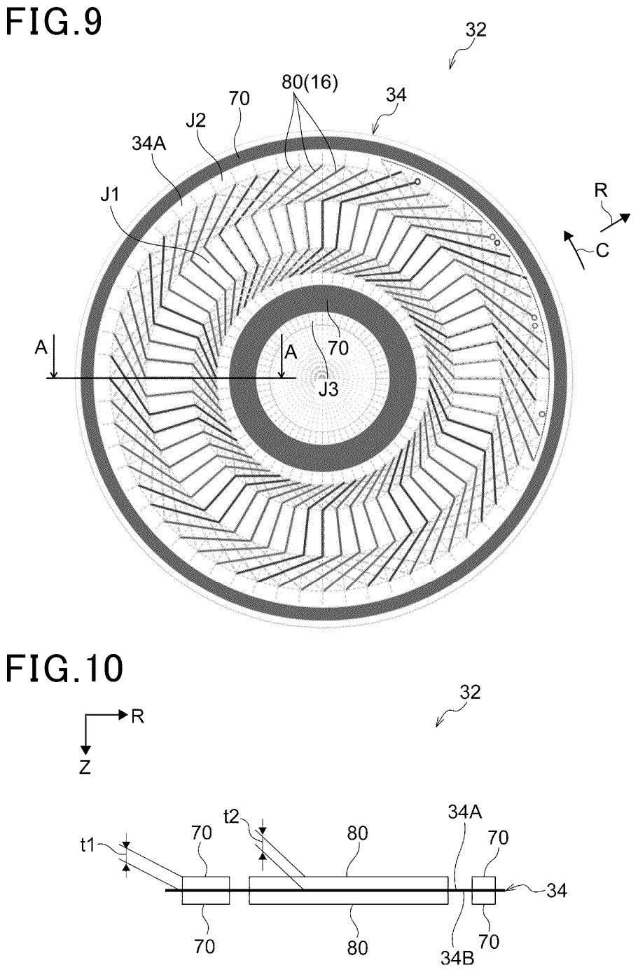

The coil body 32 of a motor according to a first embodiment will be described with reference to FIG. 9 and FIG. 10. Here, in the motor according to the first embodiment, the members and sections corresponding to those of the motor 10 described above are given the same reference numbers as the corresponding members and sections of the motor 10 described above. Descriptions thereof may be omitted.

FIG. 9 shows a single substrate 34 configuring a portion of the coil body 32 of the motor according to the first embodiment, and the plurality of coil portions 16 and the like formed on the substrate 34. As shown in the drawing, in the coil body 32 according to the present embodiment, a reinforcing portion 70 for ensuring the strength of the coil body 32 is formed on the substrate 34.

Here, a region in which the coil portion 16 (magnetic field generation portion 80) is formed in an intermediate portion of the substrate 34 in the radial direction is referred to as a coil portion formation region J1. In addition, a region in an end portion of the substrate 34 on the outer side in the radial direction in which the coil portion 16 (magnetic field generation portion 80) is not formed is referred to as a first end portion region J2. Furthermore, a region in an end portion of the substrate 34 on the inner side in the radial direction in which the coil portion 16 (magnetic field generation portion 80) is not formed is referred to as a second end portion region J3.

As shown in FIG. 9 and FIG. 10, the reinforcing portion 70 is formed on each of the surface 34A on one side and the surface 34B on the other side in the first end portion region J2 of the substrate 34. In addition, the reinforcing portion 70 is formed on each of the surface 34A on one side and the surface 34B on the other side in the second end portion region J3 of the substrate 34. In other words, the reinforcing portion 70 is formed only in the first end portion region J2 and the second end portion region J3 of the substrate 34. The reinforcing portion 70 is not formed in the coil portion formation region J1 of the substrate 34. Furthermore, the reinforcing portion 70 formed in the first end portion region J2 is formed continuously over an overall area in the circumferential direction. Also, the reinforcing portion 70 formed in the second end portion region J3 is formed continuously over an overall area in the circumferential direction. As a result, the reinforcing portion 70 formed in the first end portion region J2 and the reinforcing portion 70 formed in the second end portion region J3 have an annular shape when viewed from the axial direction.

For example, the reinforcing portion 70 may be formed using a copper material that is the same material as that of the coil portion 16 configuring the magnetic field generation portion 80. According to the present embodiment, the reinforcing portion 70 is formed on the substrate 34 when the magnetic field generation portion 80 is formed on the substrate 34. Here, for example, the magnetic field generation portion 80 and the reinforcing portion 70 may be formed into a predetermined pattern by undergoing a process referred to as etching. A thickness dimension t1 of the reinforcing portion 70 is set to be the same dimension as a thickness dimension t2 of the magnetic field generation portion 80. In addition, according to the present embodiment, the reinforcing portion 70 and the magnetic field generation portion 80 are configured not to be electrically connected to each other.

In the coil body 32 of the motor according to the present embodiment described above, the configuration is such that the first end portion region J2 and the second end portion region J3 of each substrate 34 are reinforced by the reinforcing portions 70. As a result, the strength of the coil body 32 is ensured, compared to a configuration in which the reinforcing portion 70 is not provided. In addition, rigidity of the coil body 32 can be ensured. Furthermore, the annular shape of the coil body 32 can be maintained with high precision. Moreover, excessive weight increase can be suppressed by the configuration being such that the reinforcing portion 70 is not formed in the coil portion formation region J1.

In addition, according to the present embodiment, deformation of the first end portion region J2 and the second end portion region J3 of the substrate 34 when the first end portion region J2 and the second end portion region J3 of the substrate 34 are grasped by a robot or the like, during assembly of the coil body 32 and the like, can be suppressed. As a result, handleability of the substrate 34 during a manufacturing process of the coil body 32 can be made favorable. Furthermore, as a result of only the portion of the substrate 34 reinforced by the reinforcing portions 70 being grasped by a robot or the like, the robot or the like coming into contact with the magnetic field generation portion 80 can be prevented or suppressed.

In addition, according to the present embodiment, the thickness dimension t1 of the reinforcing portion 70 is set to the same dimension as the thickness dimension t2 of the magnetic field generation portion 80. As a result, the reinforcing portion 70 interfering with reduction of clearance between the magnetic field generation portion 80 formed on one substrate 34 and the magnetic field generation portion 80 formed on another substrate 34 adjacent to each other in the axial direction can be suppressed. As a result, decrease in space factor of the coil body 32 can be suppressed by the reinforcing portion 70 being provided. Here, a configuration in which the thickness dimension t1 of the reinforcing portion 70 is set to a smaller dimension than the thickness dimension t2 of the magnetic field generation portion 80 is also possible. The thickness dimension of the reinforcing portion 70 may be set as appropriate taking into consideration the strength, rigidity, and the like required of the coil body 32.

### Second Embodiment

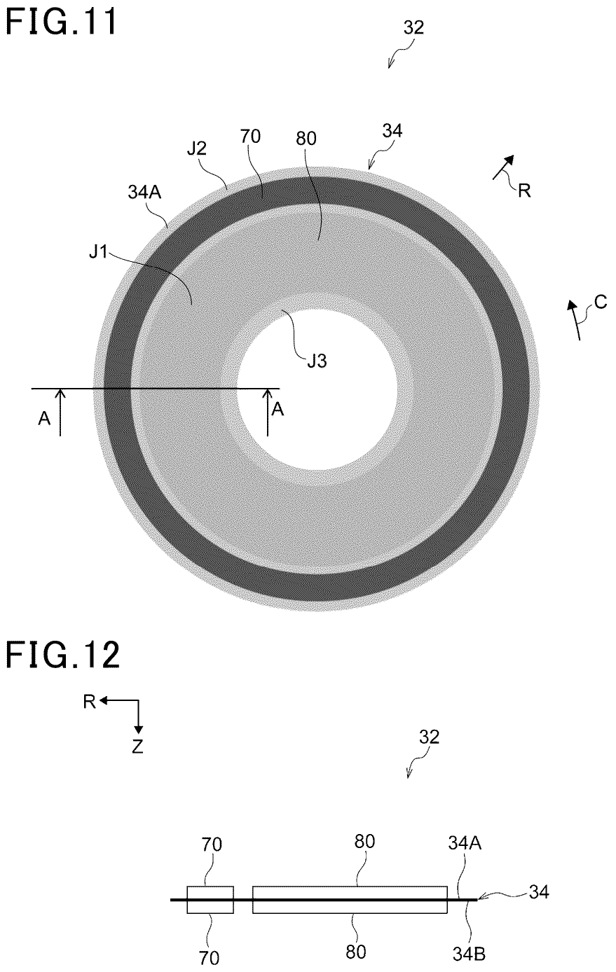

The coil body 32 of a motor according to a second embodiment will be described with reference to FIG. 11 and FIG. 12. Here, in the motor according to the second embodiment, the members and sections corresponding to those of the motor 10 described above and the motor according to the first embodiment are given the same reference numbers as the corresponding members and sections of the motor 10 described above and the like. Descriptions thereof may be omitted.

FIG. 11 and FIG. 12 schematically show a single substrate 34 configuring a portion of the coil body 32 of the motor according to the second embodiment, and the magnetic field generation portion 80 and the like formed on the substrate 34. As shown in the drawing, in the coil body 32 according to the present embodiment, the reinforcing portion 70 for ensuring the strength of the coil body 32 is formed on each of the surface 34A on one side and the surface 34B on the other side in the first end portion region J2 of the substrate 34. In other words, the reinforcing portion 70 is formed only in the first end portion region J2 of the substrate 34. The reinforcing portion 70 is not formed in the coil portion formation region J1 of the substrate 34. In the configuration according to the present embodiment as well, the strength and rigidity of the coil body 32 can be ensured, compared to a configuration in which the reinforcing portion 70 is not provided.

### Third Embodiment

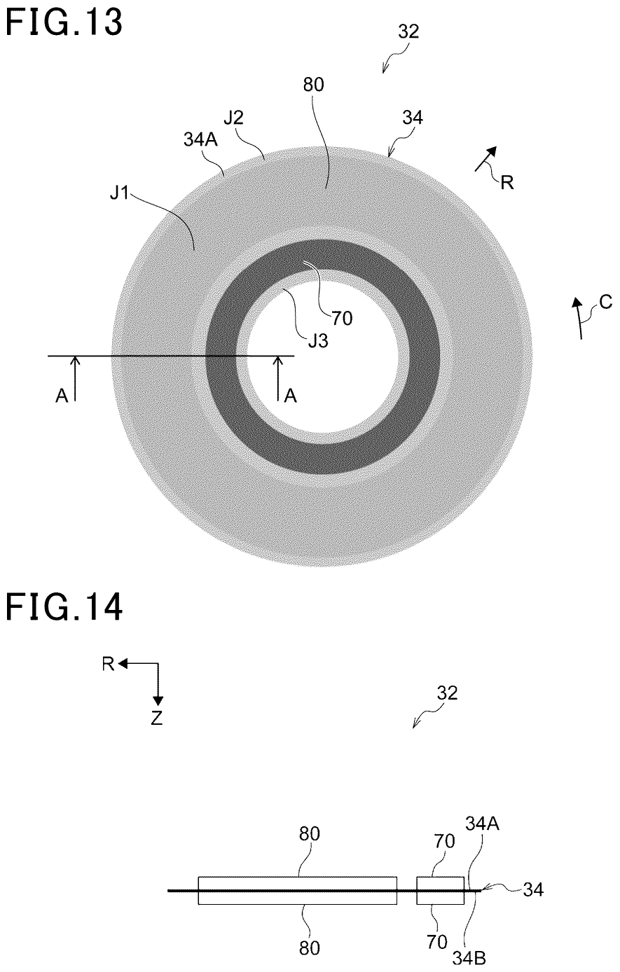

The coil body 32 of a motor according to a third embodiment will be described with reference to FIG. 13 and FIG. 14. Here, in the motor according to the third embodiment, the members and sections corresponding to those of the motor 10 described above and the motors according to the embodiments are given the same reference numbers as the corresponding members and sections of the motor 10 described above and the like. Descriptions thereof may be omitted.

FIG. 13 and FIG. 14 schematically show a single substrate 34 configuring a portion of the coil body 32 of the motor according to the third embodiment, and the magnetic field generation portion 80 and the like formed on the substrate 34. As shown in the drawing, in the coil body 32 according to the present embodiment, the reinforcing portion 70 for ensuring the strength of the coil body 32 is formed on each of the surface 34A on one side and the surface 34B on the other side in the second end portion region J3 of the substrate 34. In other words, the reinforcing portion 70 is formed only in the second end portion region J3 of the substrate 34. The reinforcing portion 70 is not formed in the coil portion formation region J1 of the substrate 34. In the configuration according to the present embodiment as well, the strength and rigidity of the coil body 32 can be ensured, compared to a configuration in which the reinforcing portion 70 is not provided.

### Fourth Embodiment

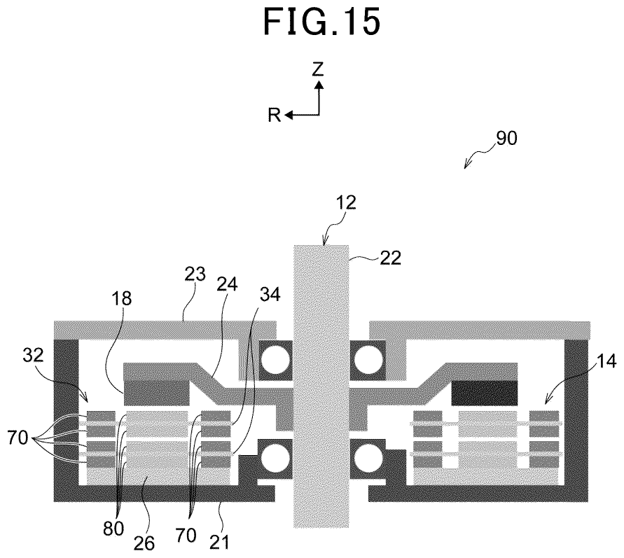

A motor 90 according to a fourth embodiment will be described with reference to FIG. 15. Here, in the motor 90 according to the fourth embodiment, the members and sections corresponding to those of the motor 10 described above and the motors according to the embodiments are given the same reference numbers as the corresponding members and sections of the motor 10 described above and the like. Descriptions thereof may be omitted.

As shown in FIG. 15, the motor 90 according to the present embodiment is a motor (referred to herein as a “single-gap motor”) configured such that the magnet 18 of the rotor 12 is disposed on only one side in the axial direction relative to the stator 14, in a manner similar to the motor 10 described above. In addition, a configuration of the coil body 32 of the motor 90 according to the present embodiment is similar to the configuration of the coil body 32 of the motor according to the first embodiment described above. Furthermore, the coil body 32 according to the present embodiment has a configuration in which two substrates 34 are stacked.

Here, in the motor 90 according to the present embodiment, the magnetic field generation portion 80 formed on each substrate 34 is disposed in the same position in the radial direction as the magnet 18 of the rotor 12. That is, the configuration is such that the magnetic field generation portion 80 formed on each substrate 34 is disposed on an extension of the magnet 18 of the rotor 12 in the axial direction. In addition, the configuration is such that the reinforcing portion 70 formed on each substrate 34 is disposed at a position offset in the radial direction relative to the magnet 18 of the rotor 12. That is, the reinforcing portion 70 formed on each substrate 34 is not positioned on the extension of the magnet 18 of the rotor 12 in the axial direction. As a result, in the motor 90 according to the present embodiment, eddy current loss accompanying leakage magnetic flux from the magnet 18 to the reinforcing portion 70 can be suppressed, compared to a configuration in which the reinforcing portion 70 formed on each substrate 34 is disposed on the extension of the magnet 18 of the rotor 12 in the axial direction. Consequently, efficiency of the motor 90 can be increased.

### Fifth Embodiment

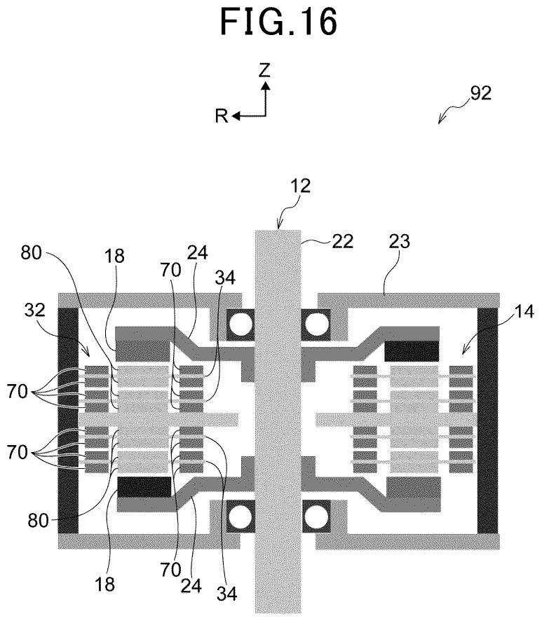

A motor 92 according to a fifth embodiment will be described with reference to FIG. 16. Here, in the motor 92 according to the fifth embodiment, the members and sections corresponding to those of the motor 10 described above and the motors according to the embodiments are given the same reference numbers as the corresponding members and sections of the motor 10 described above and the like. Descriptions thereof may be omitted.

As shown in FIG. 16, the motor 92 according to the present embodiment is a motor (referred to herein as a “double-gap motor”) configured such that the magnet 18 of the rotor 12 is disposed on each of both sides in the axial direction relative to the stator 14. In addition, a configuration of the coil body 32 of the motor 92 according to the present embodiment is similar to the configuration of the coil body 32 of the motor according to the first embodiment described above. Furthermore, a configuration of the stator 14 of the motor 92 according to the present embodiment is such that two substrates 34 are stacked on one side in the axial direction relative to the stator core 26 and two substrates 34 are stacked on the other side in the axial direction relative to the stator core 26.

In the motor 92 according to the present embodiment, in a manner similar to the motor 90 according to the fourth embodiment, the reinforcing portion 70 formed on each substrate 34 is configured to not be positioned on the extension of the magnet 18 of the rotor 12 in the axial direction. As a result, in the motor 92 according to the present embodiment, eddy current loss accompanying leakage magnetic flux from the magnet 18 to the reinforcing portion 70 can be suppressed, compared to a configuration in which the reinforcing portion 70 formed on each substrate 34 is disposed on the extension of the magnet 18 of the rotor 12 in the axial direction. Consequently, efficiency of the motor 92 can be increased.

### Sixth Embodiment

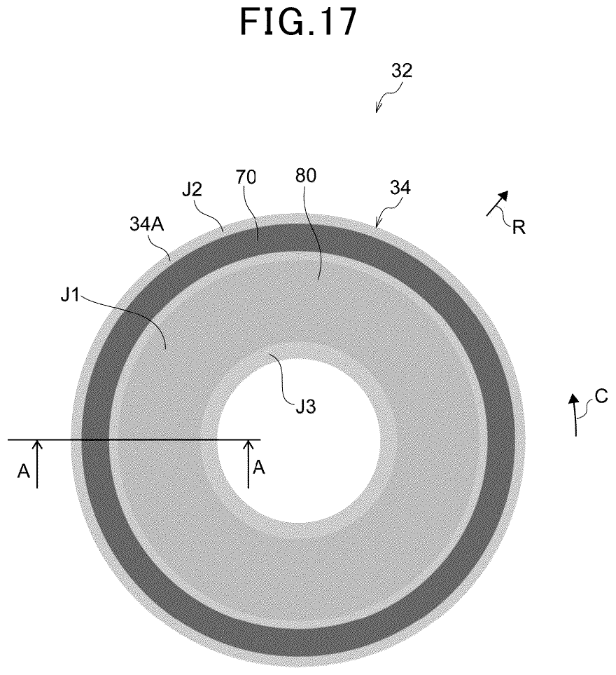

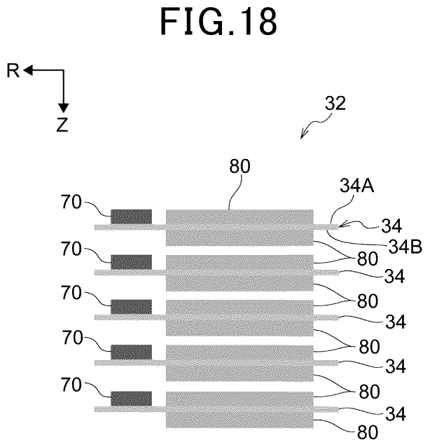

The coil body 32 of a motor according to a sixth embodiment will be described with reference to FIG. 17 and FIG. 18. Here, in the motor according to the sixth embodiment, the members and sections corresponding to those of the motor 10 described above and the motors according to the embodiments are given the same reference numbers as the corresponding members and sections of the motor 10 described above and the like. Descriptions thereof may be omitted.

FIG. 17 and FIG. 18 schematically show a single substrate 34 configuring a portion of the coil body 32 of the motor according to the sixth embodiment, and the magnetic field generation portion 80 and the like formed on the substrate 34. As shown in the drawing, in the coil body 32 according to the present embodiment, the reinforcing portion 70 for ensuring the strength of the coil body 32 is formed on the surface 34A on one side in the first end portion region J2 of the substrate 34. That is, the reinforcing portion 70 is formed only on a surface on one side in the first end portion region J2 of the substrate 34. In the configuration according to the present embodiment as well, the strength and rigidity of the coil body 32 can be ensured, compared to a configuration in which the reinforcing portion 70 is not provided.

### Seventh Embodiment

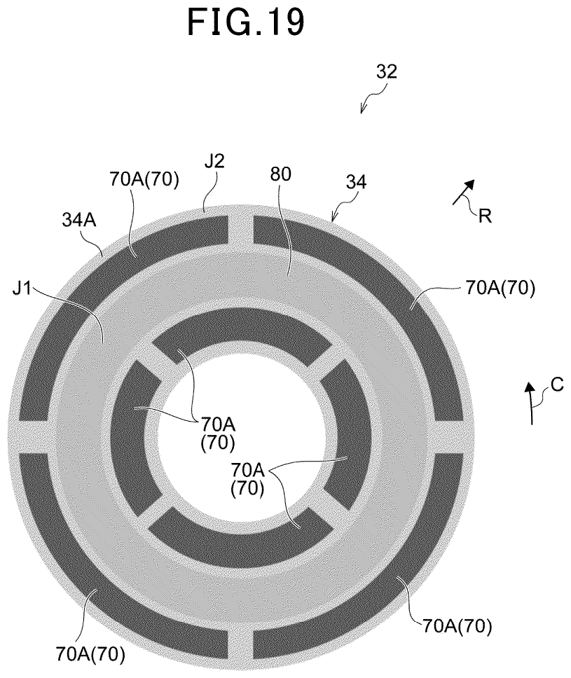

The coil body 32 of a motor according to a seventh embodiment will be described with reference to FIG. 19. Here, in the motor according to the seventh embodiment, the members and sections corresponding to those of the motor 10 described above and the motors according to the embodiments are given the same reference numbers as the corresponding members and sections of the motor 10 described above and the like. Descriptions thereof may be omitted.

FIG. 19 schematically show a single substrate 34 configuring a portion of the coil body 32 of the motor according to the seventh embodiment, and the magnetic field generation portion 80 and the like formed on the substrate 34. As shown in the drawing, in the coil body 32 according to the present embodiment, the reinforcing portion 70 is formed on each of the surface 34A on one side in the first end portion region J2 of the substrate and the surface 34A on one side in the second end portion region J3. The reinforcing portion 70 formed in the first end portion region J2 is interrupted at four locations in the circumferential direction. In addition, the reinforcing portion 70 formed in the second end portion region J3 is interrupted at four locations in the circumferential direction. Here, the reinforcing portion 70 formed in the first end portion region J2 can also be considered as being configured to be divided into four reinforcing portion pieces 70A. The reinforcing portion 70 formed in the second end portion region J3 can also be considered to be configured as being divided into four reinforcing portion pieces 70A. The four reinforcing portion pieces 70A formed in the first end portion region J2 are disposed at equal intervals in the circumferential direction. The four reinforcing pieces 70A formed in the second end portion region J3 are also disposed at equal intervals in the circumferential direction. Moreover, positions in the circumferential direction of the four reinforcing portion pieces 70A formed in the first end portion region J2 are respectively offset 45° in the circumferential direction relative to circumferential positions of the four reinforcing portion pieces 70A formed in the second end portion region J3.

In the configuration according to the present embodiment described above as well, the strength and rigidity of the coil body 32 can be ensured, compared to a configuration in which the reinforcing portion 70 is not provided. In addition, according to the present embodiment, the reinforcing portion 70 formed in the first end portion region J2 is configured to be divided into the four reinforcing portion pieces 70A, and the reinforcing portion 70 formed in the second end portion region J3 is configured to be divided into the four reinforcing portion pieces 70A. As a result, leakage magnetic flux from the magnet 18 to the reinforcing portion 70 side can be reduced, compared to a configuration in which the reinforcing portion 70 formed in the first end portion region J2 and the reinforcing portion 70 formed in the second end portion region J3 are not divided in the circumferential direction. Therefore, eddy current loss accompanying leakage magnetic flux from the magnet 18 to the reinforcing portion 70 side can be suppressed. Consequently, efficiency of the motor can be increased.

### Eighth Embodiment

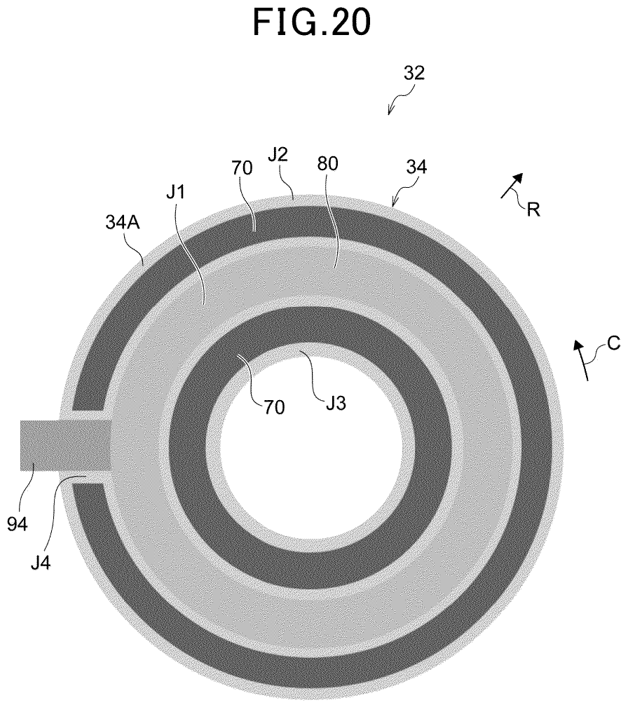

The coil body 32 of a motor according to an eighth embodiment will be described with reference to FIG. 20. Here, in the motor according to the eighth embodiment, the members and sections corresponding to those of the motor 10 described above and the motors according to the embodiments are given the same reference numbers as the corresponding members and sections of the motor 10 described above and the like. Descriptions thereof may be omitted.

FIG. 20 schematically show a single substrate 34 configuring a portion of the coil body 32 of the motor according to the eighth embodiment, and the magnetic field generation portion 80 and the like formed on the substrate 34. As shown in the drawing, in the coil body 32 according to the present embodiment, the reinforcing portion 70 is formed on each of the surface 34A on one side in the first end portion region J2 of the substrate and the surface 34A on one side in the second end portion region J3. A portion of the reinforcing portion 70 formed in the second end portion region J3 is interrupted at one location in the circumferential direction. In addition, the reinforcing portion 70 formed in the second end portion region J3 is formed continuously over the overall area in the circumferential direction. As a result, the reinforcing portion 70 formed in the first end portion region J2 has a C-shape when viewed from the axial direction, and the reinforcing portion 70 formed in the second end portion region J3 has an annular shape when viewed from the axial direction. Here, at a portion J4 in which the reinforcing portion 70 is interrupted in the circumferential direction in the first end portion region J2, various wires 94 connected to the magnetic field generation portion 80 are routed outward in the radial direction. In this manner, according to the present embodiment, interferences between the reinforcing portion 70 and the routing of the various wires 94 can be suppressed.

### Ninth Embodiment

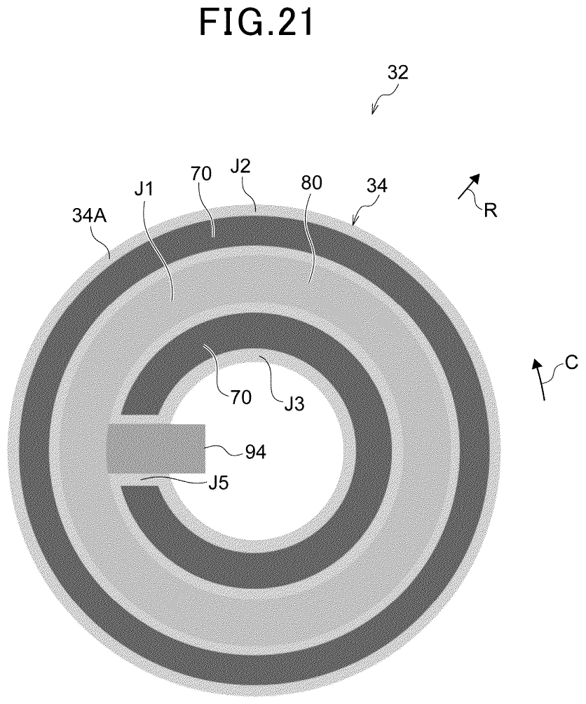

The coil body 32 of a motor according to a ninth embodiment will be described with reference to FIG. 21. Here, in the motor according to the ninth embodiment, the members and sections corresponding to those of the motor 10 described above and the motors according to the embodiments are given the same reference numbers as the corresponding members and sections of the motor 10 described above and the like. Descriptions thereof may be omitted.

FIG. 21 schematically show a single substrate 34 configuring a portion of the coil body 32 of the motor according to the ninth embodiment, and the magnetic field generation portion 80 and the like formed on the substrate 34. As shown in the drawing, in the coil body 32 according to the present embodiment, the reinforcing portion 70 is formed on each of the surface 34A on one side in the first end portion region J2 of the substrate and the surface 34A on one side in the second end portion region J3. A portion of the reinforcing portion 70 formed in the first end portion region J2 is formed continuously over the overall area in the circumferential direction. In addition, the reinforcing portion 70 formed in the second end portion region J3 is interrupted at one location in the circumferential direction. As a result, the reinforcing portion 70 formed in the first end portion region J2 has an annular shape when viewed from the axial direction, and the reinforcing portion 70 formed in the second end portion region J3 has a C-shape when viewed from the axial direction. Here, at a portion J5 in which the reinforcing portion 70 is interrupted in the circumferential direction in the second end portion region J3, the various wires 94 connected to the magnetic field generation portion 80 are routed inward in the radial direction. In this manner, according to the present embodiment, the reinforcing portion 70 interfering with the routing of the various wires 94 can be suppressed.

### Tenth Embodiment

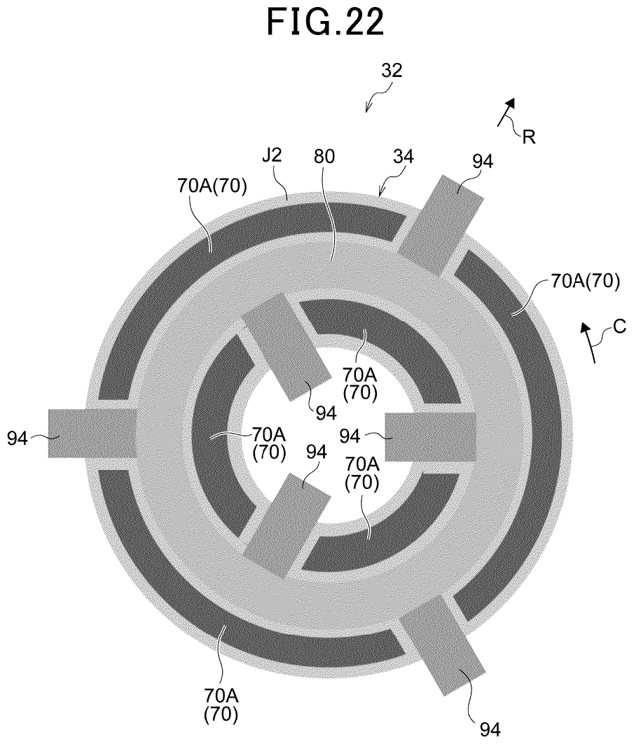

The coil body 32 of a motor according to a tenth embodiment will be described with reference to FIG. 22. Here, in the motor according to the tenth embodiment, the members and sections corresponding to those of the motor 10 described above and the motors according to the embodiments are given the same reference numbers as the corresponding members and sections of the motor 10 described above and the like. Descriptions thereof may be omitted.

FIG. 22 schematically show a single substrate 34 configuring a portion of the coil body 32 of the motor according to the tenth embodiment, and the magnetic field generation portion 80 and the like formed on the substrate 34. As shown in the drawing, in the coil body 32 according to the present embodiment, the reinforcing portion 70 is formed on each of the surface 34A on one side in the first end portion region J2 of the substrate and the surface 34A on one side in the second end portion region J3. The reinforcing portion 70 formed in the first end portion region J2 is interrupted at three locations in the circumferential direction. In addition, the reinforcing portion 70 formed in the second end portion region J3 is interrupted at three locations in the circumferential direction. Here, the reinforcing portion 70 formed in the first end portion region J2 can also be considered as being configured to be divided into three reinforcing portion pieces 70A. The reinforcing portion 70 formed in the second end portion region J3 can also be considered to be configured as being divided into three reinforcing portion pieces 70A. The three reinforcing portion pieces 70A formed in the first end portion region J2 are disposed at equal intervals in the circumferential direction. The three reinforcing portion pieces 70A formed in the second end portion region J3 are disposed at equal intervals in the circumferential direction. Moreover, the positions in the circumferential direction of the three reinforcing portion pieces 70A formed in the first end portion region J2 are respectively offset 60° in the circumferential direction relative to the positions in the circumferential direction of the three reinforcing portion pieces 70A formed in the second end portion region J3.

In addition, the various wires 94 connected to the magnetic field generation portion 80 are routed outward in the radial direction between the reinforcing pieces 70A adjacent to each other in the circumferential direction in the first end portion region J2. According to the present embodiment, the various wires 94 are routed outward in the radial direction at three locations in the first end portion region J2. Furthermore, the various wires 94 connected to the magnetic field generation portion 80 are routed inward in the radial direction between the reinforcing pieces 70A adjacent to each other in the circumferential direction in the second end portion region J3. According to the present embodiment, the various wires 94 are routed inward in the radial direction at three locations in the second end portion region J3. In this manner, according to the present embodiment, the reinforcing portion 70 interfering with the routing of the various wires 94 can be suppressed.

### Eleventh Embodiment

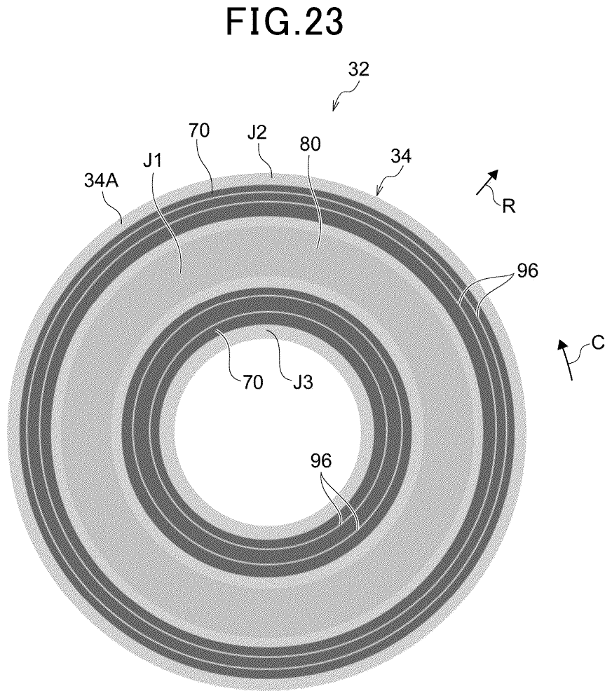

The coil body 32 of a motor according to an eleventh embodiment will be described with reference to FIG. 23. Here, in the motor according to the eleventh embodiment, the members and sections corresponding to those of the motor 10 described above and the motors according to the embodiments are given the same reference numbers as the corresponding members and sections of the motor 10 described above and the like. Descriptions thereof may be omitted.

FIG. 23 schematically show a single substrate 34 configuring a portion of the coil body 32 of the motor according to the eleventh embodiment, and the magnetic field generation portion 80 and the like formed on the substrate 34. As shown in the drawing, in the coil body 32 according to the present embodiment, the reinforcing portion 70 is formed on each of the surface 34A on one side in the first end portion region J2 of the substrate and the surface 34A on one side in the second end portion region J3. The reinforcing portion 70 formed in the first end portion region J2 is formed continuously over the overall area in the circumferential direction. In addition, the reinforcing portion 70 formed in the second end portion region J3 is formed continuously over the overall area in the circumferential direction. Here, the reinforcing portion 70 in the first end portion region J2 is divided into three parts in the radial direction by two slits 96. The reinforcing portion 70 in the second end portion region J3 is also divided into three parts in the radial direction by two slits 96.

In the configuration according to the present embodiment described above as well, the strength and rigidity of the coil body 32 can be ensured, compared to a configuration in which the reinforcing portion 70 is not provided. In addition, according to the present embodiment, the reinforcing portion 70 formed in the first end portion region J2 is configured to be divided in the radial direction by the slits 96, and the reinforcing portion 70 formed in the second end portion region J3 is configured to be divided in the radial direction by the slits 96. As a result, leakage magnetic flux from the magnet 18 to the reinforcing portion 70 side can be reduced, compared to a configuration in which the reinforcing portion 70 formed in the first end portion region J2 and the reinforcing portion 70 formed in the second end portion region J3 are not divided in the radial direction. Therefore, eddy current loss accompanying leakage magnetic flux from the magnet 18 to the reinforcing portion 70 side can be suppressed. Consequently, efficiency of the motor can be increased.

### Twelfth Embodiment

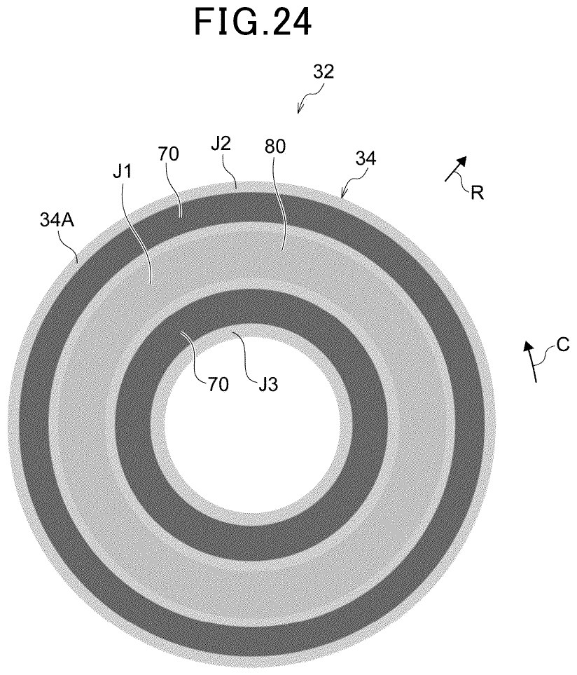

The coil body 32 of a motor according to a twelfth embodiment will be described with reference to FIG. 24. Here, in the motor according to the twelfth embodiment, the members and sections corresponding to those of the motor 10 described above and the motors according to the embodiments are given the same reference numbers as the corresponding members and sections of the motor 10 described above and the like. Descriptions thereof may be omitted.

FIG. 24 schematically show a single substrate 34 configuring a portion of the coil body 32 of the motor according to the twelfth embodiment, and the magnetic field generation portion 80 and the like formed on the substrate 34. As shown in the drawing, in the coil body 32 according to the present embodiment, the reinforcing portion 70 is formed on each of the surface 34A on one side in the first end portion region J2 of the substrate and the surface 34A on one side in the second end portion region J3. The reinforcing portion 70 formed in the first end portion region J2 is formed continuously over the overall area in the circumferential direction. In addition, the reinforcing portion 70 formed in the second end portion region J3 is formed continuously over the overall area in the circumferential direction. Here, the reinforcing portion 70 in the first end portion region J2 and the reinforcing portion 70 in the second end portion region J3 are each formed using a steel material.

In the coil body 32 of the motor according to the present embodiment described above, the strength and rigidity of the coil body 32 can be improved, compared to a configuration in which the reinforcing portion 70 in the first end portion region J2 and the reinforcing portion 70 in the second end portion region J3 are formed using a copper material.

### Thirteenth Embodiment

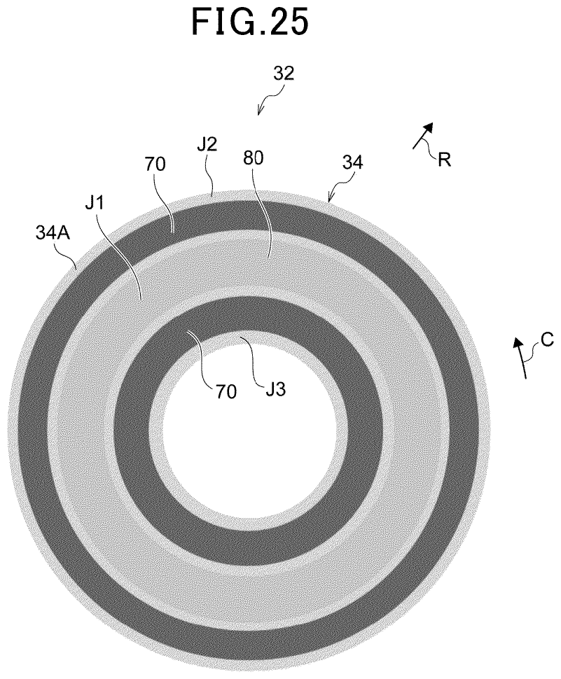

The coil body 32 of a motor according to a thirteenth embodiment will be described with reference to FIG. 25. Here, in the motor according to the thirteenth embodiment, the members and sections corresponding to those of the motor 10 described above and the motors according to the embodiments are given the same reference numbers as the corresponding members and sections of the motor 10 described above and the like. Descriptions thereof may be omitted.

FIG. 25 schematically show a single substrate 34 configuring a portion of the coil body 32 of the motor according to the thirteenth embodiment, and the magnetic field generation portion 80 and the like formed on the substrate 34. As shown in the drawing, the coil body 32 of the motor according to the present embodiment is configured in a manner similar to the coil body 32 of the motor according to the twelfth embodiment described above, aside from the reinforcing portion 70 formed in the first end portion region J2 and the reinforcing portion 70 formed in the second end portion region J3 being formed using a resin material.

In the coil body 32 of the motor according to the present embodiment described above, weight reduction of the coil body 32 can be achieved, compared to a configuration in which the reinforcing portion 70 in the first end portion region J2 and the reinforcing portion 70 in the second end portion region J3 are formed using a copper material or a steel material.

### Fourteenth Embodiment

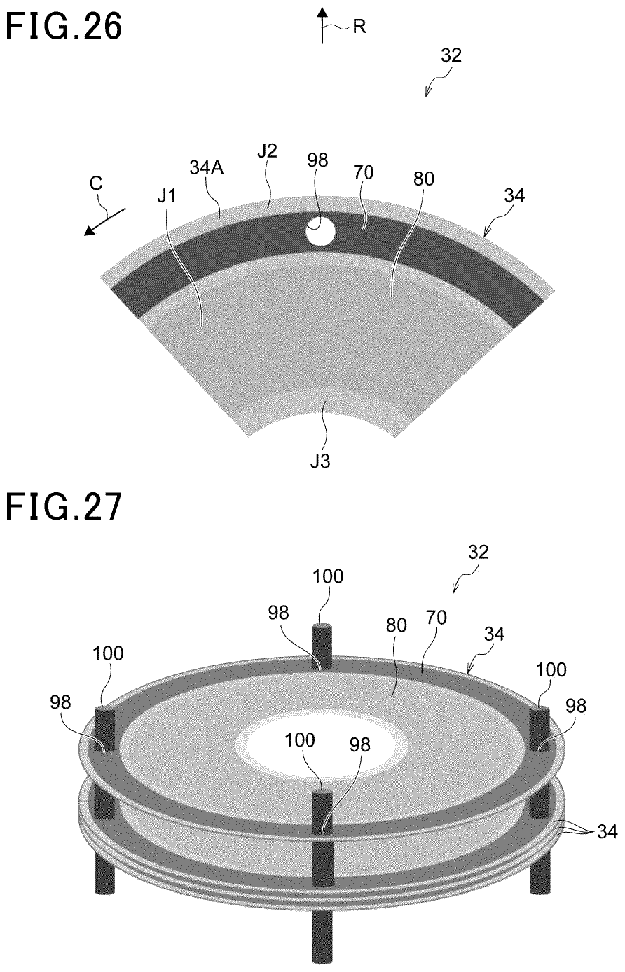

The coil body 32 of a motor according to a fourteenth embodiment will be described with reference to FIG. 26 and FIG. 27. Here, in the motor according to the fourteenth embodiment, the members and sections corresponding to those of the motor 10 described above and the motors according to the embodiments are given the same reference numbers as the corresponding members and sections of the motor 10 described above and the like. Descriptions thereof may be omitted.

FIG. 26 schematically show a portion of a single substrate 34 configuring a portion of the coil body 32 of the motor according to the fourteenth embodiment, and the magnetic field generation portion 80 and the like formed on the substrate 34. As shown in the drawing, the coil body 32 of the motor according to the present embodiment is configured in a manner similar to the coil body 32 of the motor according to the sixth embodiment described above, aside from points described hereafter.

In a center portion of the first end portion region J2 in the radial direction and a center portion of the reinforcing portion 70 in the radial direction, an engaging portion 98 that passes through both in the axial direction is formed. The engaging portion 98 according to the present embodiment is a circular opening that passes through the first end portion region J2 and the reinforcing portion 70 in the axial direction. Here, according to the present embodiment, four engaging portions 98 are formed in a single substrate 34 and the reinforcing portion 70 formed on the substrate 34. In addition, the four engaging portions 98 are disposed at equal intervals in the circumferential direction.

FIG. 27 shows four jigs 100. The four jigs 100 are formed in the shape of round rods, and are fixed to a base (not shown) in a state of being disposed at equal intervals in the circumferential direction. Then, the plurality of substrates 34 are stacked while the four jigs 100 are respectively inserted into the four engaging portions 98 formed in the first end portion region J2 of the substrate 34 and the reinforcing portion 70. In this manner, according to the present embodiment, the coil body 32 can be assembled using the four jigs 100. As a result, according to the present embodiment, positional accuracy of one substrate 34 relative to the other substrate 34 can be easily ensured, compared to a manufacturing direction in which the four jigs 100 are not used. In addition, according to the present embodiment, an edge portion of the engaging portion 98 serves as an opening edge portion of the substrate 34 and an opening edge portion of the reinforcing portion 70. This configuration is configured such that the opening edge portion of the substrate 34 is reinforced by a reinforcing portion. As a result, the opening edge portion of the substrate 34 becoming deformed by the opening edge portion of the substrate 34 coming into contact with the jig 100 can be suppressed.

Here, in the example described above, an example in which the engaging portion 98 is a circular opening is described. However, the present disclosure is not limited to thereto.

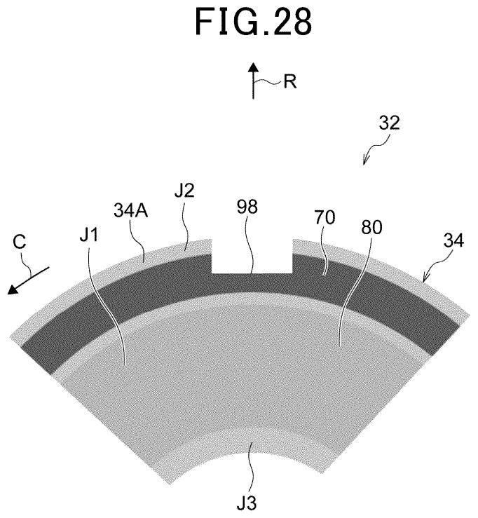

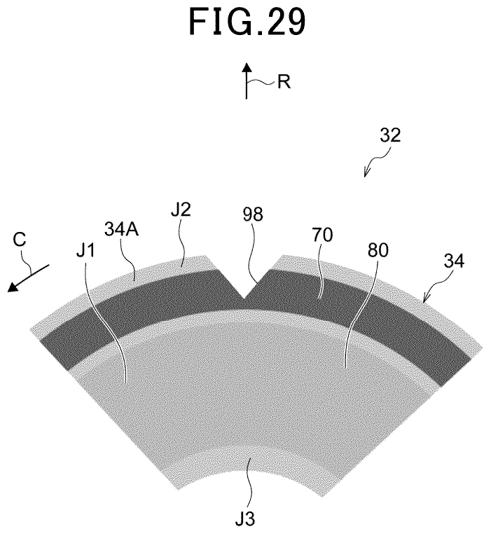

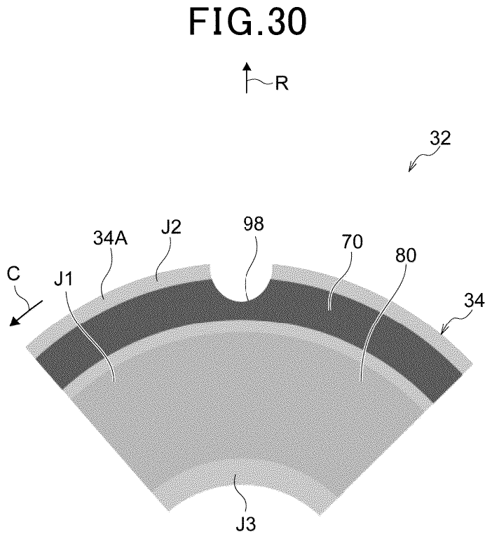

For example, as shown in FIG. 28, the engaging portion 98 may be configured such that respective outer peripheral portions of the first end portion region J2 and the reinforcing portion 70 are cut out in a rectangular shape. In addition, as shown in FIG. 29, the engaging portion 98 may be configured such that respective outer peripheral portions of the first end portion region J2 and the reinforcing portion 70 are cut out in a triangular shape. Furthermore, as shown in FIG. 30, the engaging portion 98 may be configured such that respective outer peripheral portions of the first end portion region J2 and the reinforcing portion 70 are cut out in a semicircular shape. The configuration of the engaging portion 98 may be set as appropriate, taking into consideration of the configuration of the jig 100 and the like. Also, a portion of a member configuring the motor, such as a portion of the stator core 26, may engage with the engaging portion 98.

In addition, according to the seventh embodiment to fourteenth embodiment described above, examples in which the reinforcing portion 70 is formed on only a surface on one side of the substrate 34 is described. However, the present disclosure is not limited to thereto. The configurations according to the seventh embodiment to fourteenth embodiment described above can also be applied to a configuration in which the reinforcing portions 70 are formed on both surfaces of the substrate 34.

### Fifteenth Embodiment

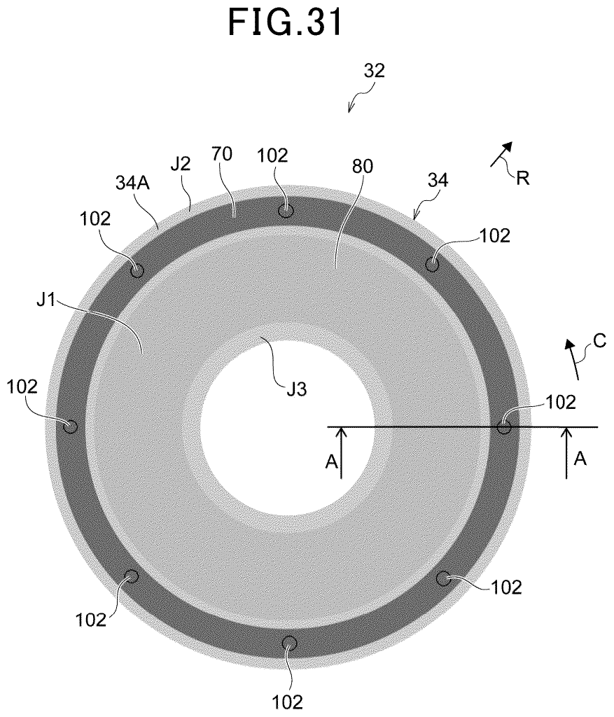

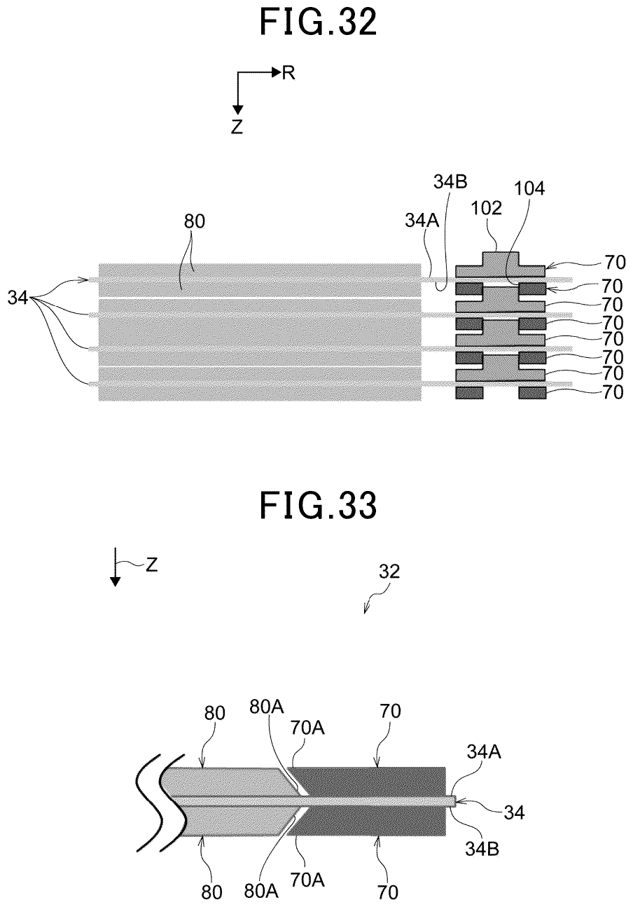

The coil body 32 of a motor according to a fifteenth embodiment will be described with reference to FIG. 31 and FIG. 32. Here, in the motor according to the fifteenth embodiment, the members and sections corresponding to those of the motor 10 described above and the motors according to the embodiments are given the same reference numbers as the corresponding members and sections of the motor 10 described above and the like. Descriptions thereof may be omitted.

FIG. 31 and FIG. 32 schematically show the coil body 32 of the motor according to the fifteenth embodiment. As shown in the drawing, the coil body 32 of the motor according to the present embodiment is configured in a manner similar to the coil body 32 of the motor according to the second embodiment described above, aside from points described hereafter.

Eight fitting protruding portions 102 that protrude toward one side in the axial direction are formed in the reinforcing portion 70 formed on the surface 34A on one side in the first end portion region J2 of the substrate 34. These eight fitting protruding portions 102 are disposed at equal intervals along the circumferential direction. In addition, eight fitting recessing portions 104 that are open on the other side in the axial direction are formed in the reinforcing portion 70 formed on the surface 34B on the other side in the first end portion region J2 of the substrate 34. These eight fitting recessing portions 104 are disposed at equal intervals along the circumferential direction, and disposed at the same positions in the circumferential direction and the radial direction as the eight fitting protruding portions 102. Here, as an example, the fitting protruding portion 102 and the fitting recessing portion 104 can be formed by press-punching after the reinforcing portions 70 are formed on both surfaces in the axial direction in the first end portion region J2 of the substrate 34.

Then, the substrates 34 of the layers are stacked in the axial direction in a state in which the fitting protruding portion 102 formed in the reinforcing portion 70 of one substrate 34 is fitted into the fitting recessing portion 104 formed in the reinforcing portion 70 of the other substrate 34. As a result, positional accuracy of the other substrate 34 relative to the one substrate 34 can be easily ensured.

Here, according to the present embodiment, an example in which the fitting protruding portion 102 and the fitting recessing portion 104 are formed in the reinforcing portion 70 in the first end portion region J2 of the substrate 34 is described. However, the present disclosure is not limited thereto. For example, the configuration may be such that the fitting protruding portion 102 and the fitting recessing portion 104 are formed in the reinforcing portion 70 in the second end portion region J3 of the substrate 34. However, angular change in the fitting protruding portion 102 and the fitting recessing portion 104 in the circumferential direction relative to an amount of shifting (distance) of the fitting protruding portion 102 and the fitting recessing portion 104 in the circumferential direction is less when the configuration is such that the fitting protruding portion 102 and the fitting recessing portion 104 are formed in the reinforcing portion 70 in the first end portion region J2 of the substrate 34 than when the configuration is such that the fitting protruding portion 102 and the fitting recessing portion 104 are formed in the reinforcing portion 70 in the second end portion region J3 of the substrate 34. Therefore, from a perspective of easily ensuring positional accuracy in the circumferential direction of the other substrate 34 relative to one substrate 34, the configuration in which the fitting protruding portion 102 and the fitting recessing portion 104 are formed in the reinforcing portion 70 in the first end portion region J2 of the substrate 34 is more advantageous than the configuration in which the fitting protruding portion 102 and the fitting recessing portion 104 are formed in the reinforcing portion 70 in the second end portion region J3 of the substrate 34.

### Sixteenth Embodiment

The coil body 32 of a motor according to a sixteenth embodiment will be described with reference to FIG. 33. Here, in the motor according to the sixteenth embodiment, the members and sections corresponding to those of the motor 10 described above and the motors according to the embodiments are given the same reference numbers as the corresponding members and sections of the motor 10 described above and the like. Descriptions thereof may be omitted.

FIG. 33 schematically show a single substrate 34 configuring a portion of the coil body 32 of the motor according to the sixteenth embodiment, and the magnetic field generation portion 80 and the like formed on the substrate 34. As shown in the drawing, according to the present embodiment, an end portion 70B on the magnetic field generation portion 80 side of the reinforcing portion 70 formed on the surface 34A on one side of the substrate 34 and an end portion 80A on the reinforcing portion 70 side of the magnetic field generation portion 80 formed on the surface 34A on one side of the substrate 34 overlap in the axial direction. In addition, the end portion 70B on the magnetic field generation portion 80 side of the reinforcing portion 70 formed on the surface 34B on the other side of the substrate 34 and the end portion 80A on the reinforcing portion 70 side of the magnetic field generation portion 80 formed on the surface 34B on the other side of the substrate 34 overlap in the axial direction. In the configuration according to the present embodiment as well, the strength and rigidity of the coil body 32 can be ensured, compared to a configuration in which the reinforcing portion 70 is not provided.

### Seventeenth Embodiment

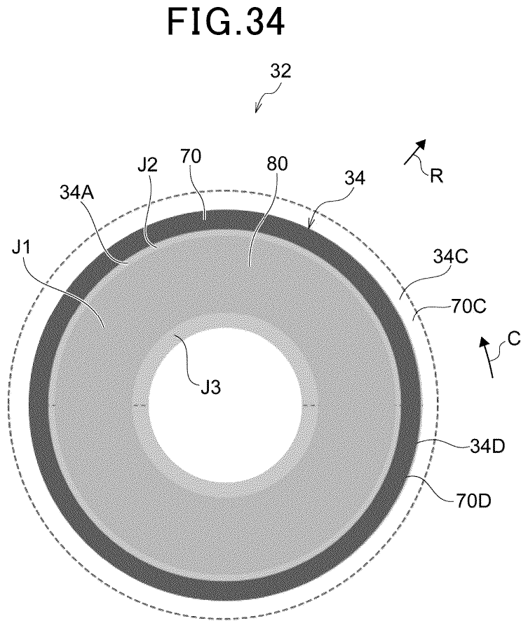

The coil body 32 of a motor according to a seventeenth embodiment will be described with reference to FIG. 34 to FIG. 36. Here, in the motor according to the seventeenth embodiment, the members and sections corresponding to those of the motor 10 described above and the motors according to the embodiments are given the same reference numbers as the corresponding members and sections of the motor 10 described above and the like. Descriptions thereof may be omitted.

FIG. 34 schematically show a single substrate 34 configuring a portion of the coil body 32 of the motor according to the seventeenth embodiment, and the magnetic field generation portion 80 and the like formed on the substrate 34. As shown in the drawing, the coil body 32 of the motor according to the present embodiment is configured in a manner similar to the coil body 32 of the motor according to the second embodiment described above, aside from points described hereafter.

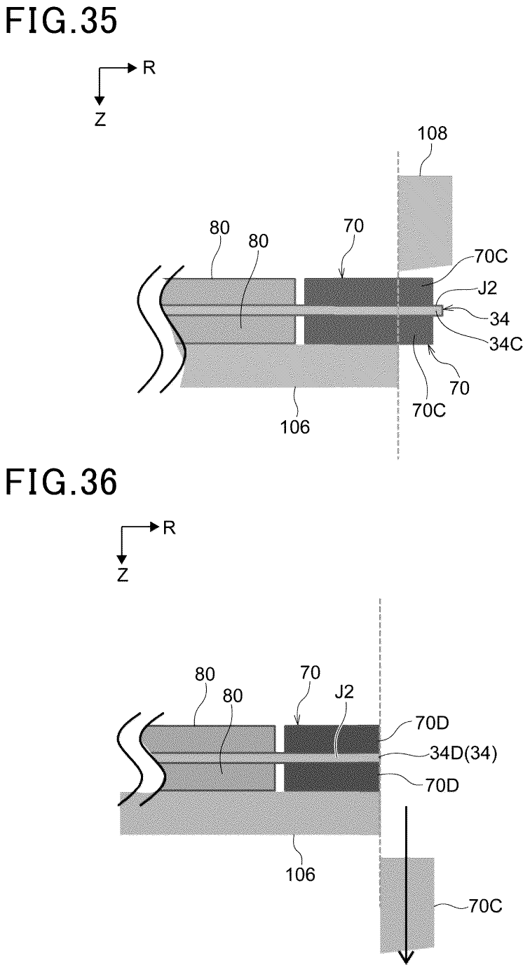

As shown in FIG. 35 and FIG. 36, according to the present embodiment, an outer peripheral end portion 34C in the first end portion region J2 of the substrate 34 and an outer peripheral end portion 70C of the reinforcing portion 70 are cut and removed by a punch 108 in a state in which the substrate 34 is set in a die 106. As a result, as shown in FIG. 34 and FIG. 36, an outer peripheral end 34D in the first end portion region J2 of the substrate 34 and an outer peripheral end 70D of the reinforcing portion 70 are flush with each other. Here, in FIG. 34, portions cut and removed by the punch 108 (the outer peripheral end portion 34C in the first end portion region J2 of the substrate 34 and the outer peripheral end portion 70C of the reinforcing portion 70) are shown by broken lines.

According to the present embodiment described above, deformation of the outer peripheral end 34D in the first end portion region J2 of the substrate 34 can be suppressed by the outer peripheral end portion 34C in the first end portion region J2 of the substrate 34 and the outer peripheral end portion 70C of the reinforcing portion 70 being flush with each other.

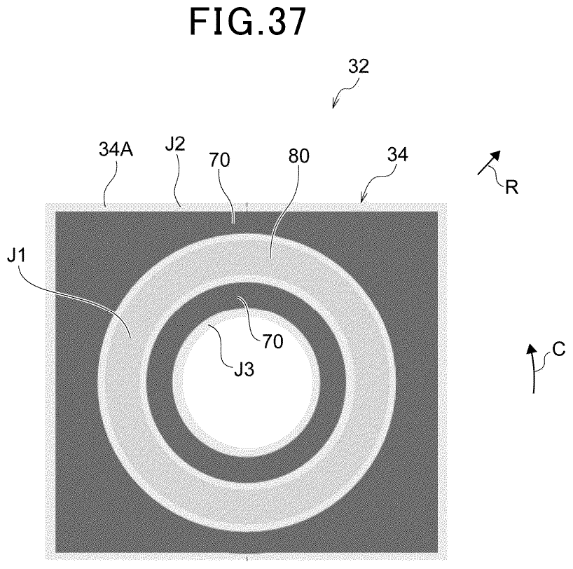

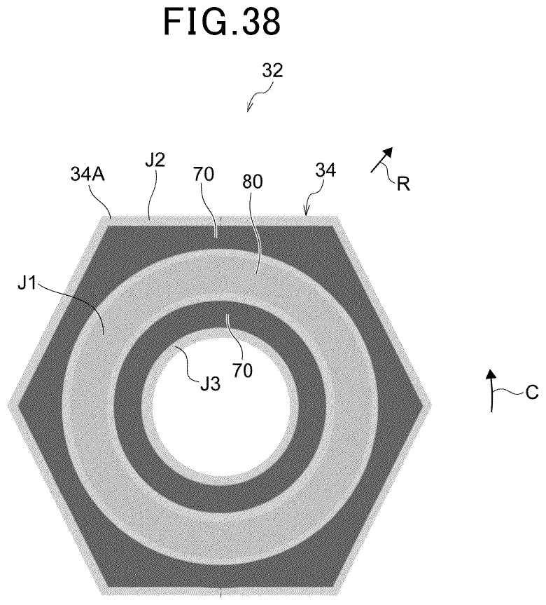

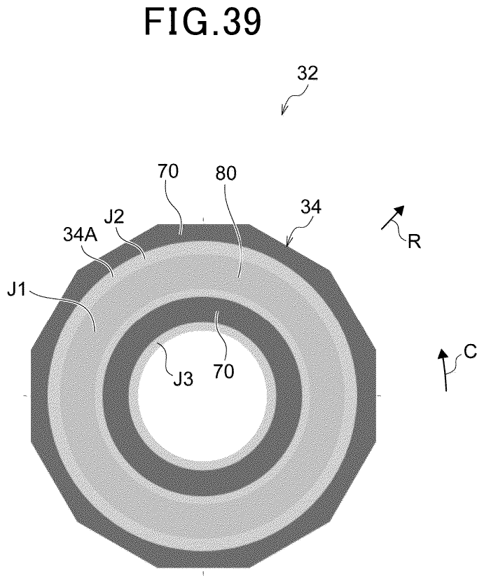

Here, according to the embodiments described above, an example in which the shape of an outer edge of the substrate 34 is circular is described. However, the present disclosure is not limited to thereto. For example, as shown in FIG. 37, the configuration may be such that the shape of the outer edge of the substrate 34 is rectangular. Also, as shown in FIG. 38, the configuration may be such that the shape of the outer edge of the substrate 34 is hexagonal. Also, as shown in FIG. 39, the configuration may be such that the shape of the outer edge of the substrate 34 is dodecagonal.

### Eighteenth Embodiment

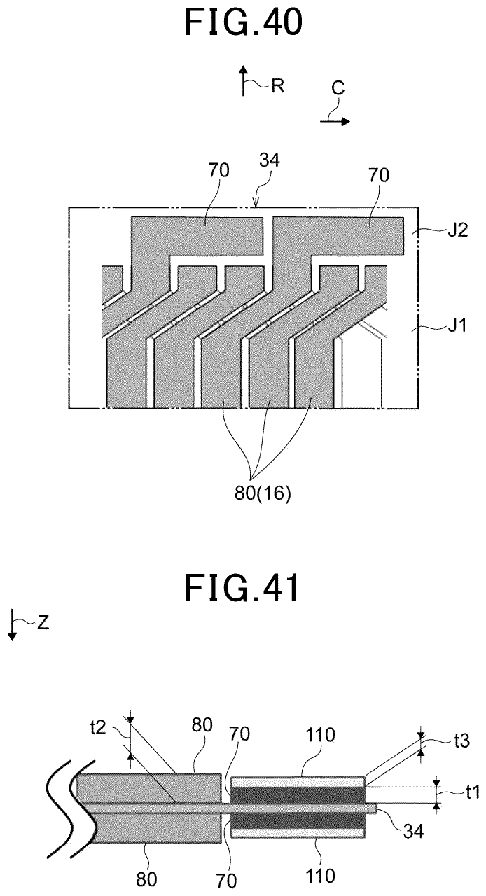

The coil body 32 of a motor according to an eighteenth embodiment will be described with reference to FIG. 40. Here, in the motor according to the eighteenth embodiment, the members and sections corresponding to those of the motor 10 described above and the motors according to the embodiments are given the same reference numbers as the corresponding members and sections of the motor 10 described above and the like. Descriptions thereof may be omitted.

As shown in FIG. 40, in the coil body 32 of the motor according to the present embodiment, the reinforcing portion 70 and the magnetic field generation portion 80 are electrically connected. In this configuration, the reinforcing portion 70 can function as a conduction path to the magnetic field generation portion 80.

### Nineteenth Embodiment

The coil body 32 of a motor according to a nineteenth embodiment will be described with reference to FIG. 41. Here, in the motor according to the nineteenth embodiment, the members and sections corresponding to those of the motor 10 described above and the motors according to the embodiments are given the same reference numbers as the corresponding members and sections of the motor 10 described above and the like. Descriptions thereof may be omitted.

As shown in FIG. 41, according to the present embodiment, the thickness dimension t1 of the reinforcing portion 70 is set to a dimension that is smaller than the thickness dimension t2 of the magnetic field generation portion 80. In addition, an insulating layer 110 formed using an insulating material is formed on the surface of the reinforcing portion 70 on a side opposite the substrate 34. Here, a dimension obtained by the thickness dimension t1 of the reinforcing portion 70 and a thickness dimension t3 of the insulating layer being added together is a dimension that is smaller than the thickness dimension t2 of the magnetic field generation portion 80. In the configuration according to the present embodiment described above as well, the strength and rigidity of the coil body 32 can be ensured, compared to a configuration in which the reinforcing portion 70 is not provided.

The embodiments of the present disclosure are described above. However, the present disclosure is not limited to that described above and can, of course, be modified in various ways in addition to that described above without departing from the spirit of the present disclosure. In addition, all or some of the configurations according to the embodiments described above can be combined with one another. For example, regarding combinations of configurations according to the embodiments, the configurations may be selected as appropriate based on intended use of the motor 10 and the like. Furthermore, the configurations of the motor 10 and the like may also be applied to a power generator. Moreover, the configurations of the present disclosure can also be applied to the rotor configured to include the coil body 32.

### SUPPLEMENTARY NOTES

### Supplementary Note 1

A coil body (32) including: a base member (34) that is formed into a shape extending in a radial direction using an insulating material and stacked in an axial direction; a magnetic field generation portion (80) that is formed in the base member using a conductive material and generates a rotating magnetic field by being energized; and a reinforcing portion (70) that is formed in a region differing from a region in which the magnetic field generation portion is formed on a surface of the base material facing the axial direction.

### Supplementary Note 2

The coil body according to the supplementary note 1, in which: the reinforcing portion is formed using a conductive material.

### Supplementary Note 3

The coil body according to the supplementary note 2, in which: the reinforcing portion serves as a conduction path to the magnetic field generation portion by the reinforcing portion and the magnetic field generation portion being electrically connected.

### Supplementary Note 4

The coil body according to any one of the supplementary notes 1 to 3, in which: a thickness dimension (t1) of the reinforcing portion in the axial direction is set to a dimension that is equal to or smaller than a thickness dimension (t2) of the magnetic field generation portion in the axial direction.

### Supplementary Note 5

The coil body according to any one of the supplementary notes 1 to 4, in which: the reinforcing portion is divided in at least either of a circumferential direction and the radial direction.

### Supplementary Note 6

The coil body according to any one of the supplementary notes 1 to 5, in which: an engaging portion (98) in which the reinforcing portion is an edge portion is formed in a region in which the reinforcing portion is formed in the base member of each layer.

### Supplementary Note 7

The coil body according to any one of the supplementary notes 1 to 6, in which: a fitting protruding portion (102) protruding toward one side in the axial direction and a fitting recessing portion (104) open on another side in the axial direction are formed in the reinforcing portion formed in the base member of each layer; and the base member of each layer is stacked in the axial direction in a state in which the fitting protruding portion formed in the reinforcing portion of one base member is fitted into the fitting recessing portion formed in the reinforcing portion of another base member.

### Supplementary Note 8

An armature (14) including: the coil body according to any one of the supplementary nodes 1 to 7.

### Supplementary Note 9

A rotating electric machine (10, 90, 92) including a stator (14) and a rotor (12), in which either of the stator and the rotor is configured to include the armature according to the supplementary note 8; and the other of the stator and the rotor includes a magnet (18) disposed opposing the coil body in the axial direction.

While the present disclosure has been described with reference to embodiments thereof, it is to be understood that the disclosure is not limited to the embodiments and constructions. The present disclosure is intended to cover various modification examples and modifications within the range of equivalency. In addition, various combinations and configurations, and further, other combinations and configurations including more, less, or only a single element thereof are also within the spirit and scope of the present disclosure.

What is claimed is:

1. A coil body comprising:
a base member that is formed into a shape extending in a radial direction using an insulating material and stacked in an axial direction;
a magnetic field generation portion that is formed in the base member using a conductive material and generates a rotating magnetic field by being energized; and
a reinforcing portion that is formed in a region differing from a region in which the magnetic field generation portion is formed on a surface of the base material facing the axial direction.

2. The coil body according to claim 1, wherein:
the reinforcing portion is formed using a conductive material.

3. The coil body according to claim 2, wherein:
the reinforcing portion serves as a conduction path to the magnetic field generation portion by the reinforcing portion and the magnetic field generation portion being electrically connected.

4. The coil body according to claim 1, wherein:
a thickness dimension of the reinforcing portion in the axial direction is set to a dimension that is equal to or smaller than a thickness dimension of the magnetic field generation portion in the axial direction.

5. The coil body according to claim 1, wherein:
the reinforcing portion is divided in at least either of a circumferential direction and the radial direction.

6. The coil body according to claim 1, wherein:
an engaging portion in which the reinforcing portion is an edge portion is formed in a region in which the reinforcing portion is formed in the base member of each layer.

7. The coil body according to claim 1, wherein:
a fitting protruding portion protruding toward one side in the axial direction and a fitting recessing portion open on another side in the axial direction are formed in the reinforcing portion formed in the base member of each layer; and
the base member of each layer is stacked in the axial direction in a state in which the fitting protruding portion formed in the reinforcing portion of one base member is fitted into the fitting recessing portion formed in the reinforcing portion of another base member.

8. An armature comprising:
a coil body, wherein the coil body comprises:
a base member that is formed into a shape extending in a radial direction using an insulating material and stacked in an axial direction;
a magnetic field generation portion that is formed in the base member using a conductive material and generates a rotating magnetic field by being energized; and
a reinforcing portion that is formed in a region differing from a region in which the magnetic field generation portion is formed on a surface of the base material facing the axial direction.

9. The armature according to claim 8, wherein:
the reinforcing portion is formed using a conductive material.

10. The armature according to claim 9, wherein:
the reinforcing portion serves as a conduction path to the magnetic field generation portion by the reinforcing portion and the magnetic field generation portion being electrically connected.

11. The armature according to claim 8, wherein:
a thickness dimension of the reinforcing portion in the axial direction is set to a dimension that is equal to or smaller than a thickness dimension of the magnetic field generation portion in the axial direction.

12. The armature according to claim 8, wherein:
the reinforcing portion is divided in at least either of a circumferential direction and the radial direction.

13. The armature according to claim 8, wherein:
an engaging portion in which the reinforcing portion is an edge portion is formed in a region in which the reinforcing portion is formed in the base member of each layer.

14. The armature according to claim 8, wherein:
a fitting protruding portion protruding toward one side in the axial direction and a fitting recessing portion open on another side in the axial direction are formed in the reinforcing portion formed in the base member of each layer; and
the base member of each layer is stacked in the axial direction in a state in which the fitting protruding portion formed in the reinforcing portion of one base member is fitted into the fitting recessing portion formed in the reinforcing portion of another base member.

15. A rotating electric machine comprising:
a stator; and
a rotor, wherein:
either of the stator and the rotor is configured to include an armature including a coil body;
the other of the stator and the rotor includes a magnet disposed opposing the coil body in an axial direction; and
the coil body comprises:
a base member that is formed into a shape extending in a radial direction using an insulating material and stacked in an axial direction;
a magnetic field generation portion that is formed in the base member using a conductive material and generates a rotating magnetic field by being energized; and
a reinforcing portion that is formed in a region differing from a region in which the magnetic field generation portion is formed on a surface of the base material facing the axial direction.

16. The rotating electric machine according to claim 15, wherein:
the reinforcing portion is formed using a conductive material.

17. The rotating electric machine according to claim 16, wherein:
the reinforcing portion serves as a conduction path to the magnetic field generation portion by the reinforcing portion and the magnetic field generation portion being electrically connected.

18. The rotating electric machine according to claim 15, wherein:
a thickness dimension of the reinforcing portion in the axial direction is set to a dimension that is equal to or smaller than a thickness dimension of the magnetic field generation portion in the axial direction.

19. The rotating electric machine according to claim 15, wherein:
the reinforcing portion is divided in at least either of a circumferential direction and the radial direction.

20. The rotating electric machine according to claim 15, wherein:
an engaging portion in which the reinforcing portion is an edge portion is formed in a region in which the reinforcing portion is formed in the base member of each layer.
